(19) United States
(12) Patent Application Publication
(10) Pub. No.: US 2024/0116020 A1
(43) Pub. Date: Apr. 11, 2024

(54) MIXER FOR REVERSE FLOW REACTOR

(71) Applicant: EXXONMOBIL TECHNOLOGY AND ENGINEERING COMPANY, Annandale, NJ (US)

(72) Inventors: Zhiyan WANG, Spring, TX (US); William R. GUNTHER, Scotch Plains, NJ (US); Changmin CHUN, Raritan, NJ (US)

(21) Appl. No.: 18/481,411

(22) Filed: Oct. 5, 2023

Related U.S. Application Data
(60) Provisional application No. 63/511,033, filed on Jun. 29, 2023.
(60) Provisional application No. 63/378,743, filed on Oct. 7, 2022.

(51) Int. Cl. B01J 19/24; B01F 23/10; B01F 25/421; B01F 25/422; B01J 19/00; C01B 3/38

(52) U.S. Cl. CPC B01J 19/2485; B01F 23/10; B01F 25/422; B01F 25/4233; B01J 19/0053; C01B 3/38; B01F 2101/501

(57) ABSTRACT

Systems and methods are provided for improving the flow distribution in the high temperature zone of a cyclic flow reactor, such as a reverse flow reactor. The systems can include a plurality of mixing plates that can facilitate mixing of flows that have been maintained separately until a mixing location. Based in part on the use of a plurality of mixing plates, methods are provided for operating a reverse flow reactor with a temperature profile that has improved uniformity across the cross-section of the reactor. In some aspects, a flame diffuser can be included downstream from the plurality of mixing plates to further improve the uniformity of the temperature distribution.

### CROSS REFERENCE TO RELATED APPLICATION

This non-provisional patent application claims priority to U.S. provisional patent app. No. 63/511,033, filed Jun. 29, 2023, and titled “MIXER FOR REVERSE FLOW REACTOR”, and U.S. provisional patent app. No. 63/378,743, filed Oct. 7, 2022, and titled “CERAMIC MONOLITH COMPOSITION”, and the entire contents of which is incorporated herein by reference.

### FIELD OF THE INVENTION

Mixer systems and corresponding methods of using such mixer systems are provided for improving flow patterns within a cyclic flow reactor.

### BACKGROUND OF THE INVENTION

Reverse flow reactors are an example of a reactor type that is beneficial for use in processes with cyclic reaction conditions. For example, due to the endothermic nature of reforming reactions, additional heat needs to be introduced on a consistent basis into the reforming reaction environment. Reverse flow reactors can provide an efficient way to introduce heat into the reaction environment. After a portion of the reaction cycle used for reforming or another endothermic reaction, a second portion of the reaction cycle can be used for combustion or another exothermic reaction to add heat to the reaction environment in preparation for the next reforming step. U.S. Pat. Nos. 7,815,873; 8,754,276 provide examples of using reverse flow reactors to perform various endothermic processes in a cyclic reaction environment.

Endothermic reactions such as reforming can also benefit from having a substantial amount of available catalytic surface area. Ceramic monolith structures are an example of a type of structure that can provide a high available surface area. One option can be to use a monolith corresponding to a packed array of cells or channels that the reactant gases pass through. Washcoats are added to such monoliths to provide catalytic activity.

Due in part to the ability to perform direct heating of the interior surfaces of a reverse flow reactor while maintaining high purity in the resulting hydrogen product, reverse flow reactors have the potential to provide substantial advantages over conventional steam reforming configurations. However, some practical challenges remain. For example, one of the difficulties with using a reverse flow reactor is managing the direct heating of the interior surfaces.

In order to improve the utilization of heat within the reactor, combustion is typically initiated at an intermediate location in the reactor, so that the peak temperature in the reactor can be toward the middle of the reactor. This can allow regions near the peak temperature to be used for reaction while also allowing at least one end of the reactor to serve as a recuperation zone to allow for recovery of heat from reaction products. One method for controlling the location of combustion is to introduce fuel and oxidant via separate volumes or channels, and then mix the fuel and oxidant at or near the desired location for combustion. While this is effective for controlling the location where combustion begins, it can be difficult to effectively mix the fuel and oxidant so that a heat is distributed relatively uniformly across the cross-section of the reactor.
U.S. Pat. Nos. 9,322,549; 7,815,873 describe mixers and/or flow distributors that are suitable for use in some reverse flow reactor configurations.
U.S. Pat. No. 11,286,427 describes a reverse flow reactor configuration with improved purge mode efficiency.
U.S. Pat. No. 8,827,544 describes a mixer for a continuous flow reactor.

### SUMMARY OF THE INVENTION

In various aspects, a reverse flow reactor is provided. The reactor includes a recuperation zone having at least one recuperation zone inlet and at least one recuperation zone outlet. The recuperation zone can have a primary flow path in fluid communication with the at least one recuperation zone inlet and the at least one recuperation zone outlet. The reactor further includes reaction zone having at least a reaction zone inlet and a reaction zone outlet. The reactor further includes one or more secondary reactor inlets in fluid communication with the recuperation zone. Additionally, the reactor includes a plurality of mixing plates arranged in series between the recuperation zone and the reaction zone. The plurality of mixing plates can include at least a first plate, a second plate, and a third plate. The first plate can be closer to the recuperation zone than the second plate and the third plate. The third plate can be closer to the reaction zone than the first plate and the second plate. The first plate can include a first inner portion and a first outer portion. The first inner portion can have an area corresponding to 20% to 40% of the cross-sectional area of the first plate. An open area of the first inner portion can correspond to 5% or less of the area of the first inner portion. The first outer portion can include a plurality of first openings. The plurality of first openings can have an open area comprising 20% to 50% of an area of the first outer portion. The second plate can include a second inner portion and a second outer portion. The second inner portion can have an area corresponding to 20% to 40% of the cross-sectional area of the second plate. An open area of the second outer portion can correspond to 5% or less of an area of the second outer portion. The second inner portion can have at least one second opening, the at least one second opening having an open area comprising 20% to 100% of the second inner portion. The third plate can have a third inner portion and a third outer portion, the third inner portion having an area corresponding to 20% to 40% of the cross-sectional area of the third plate. The third inner portion can include at least one third inner opening, the third outer portion comprising a plurality of third outer openings, an average diameter of the third outer openings being greater than an average diameter of the at least one third inner opening, the plurality of third outer openings having a combined area that is 70% or more of a total combined area of the plurality of third outer openings and the at least one third inner opening.

Such a reactor can also be used to perform an endothermic reaction. For example, such a method can include introducing a fuel flow into the recuperation zone; introducing an oxygen-containing flow into the secondary reactor inlets, the secondary reactor inlets being in fluid communication with the recuperation zone in proximity to the first plate of the plurality of mixing plates; passing the fuel flow and the oxygen-containing flow through the mixing plates to form a mixed flow; combusting at least a portion of the fuel in the mixed flow to form a heated gas flow; transferring heat from the heated gas flow to at least one surface in the reaction zone; exhausting the heated gas flow from the reaction zone; passing a reactant flow into the reaction zone; performing an endothermic reaction in the reaction zone to form a reaction product; and exhausting the reaction product from the recuperation zone, wherein the endothermic reaction optionally comprises hydrocarbon reforming.

### BRIEF DESCRIPTION OF THE DRAWINGS

FIG. 1 illustrates various possible divisions between an inner portion and an outer portion.

FIGS. 2A to 2E show examples mixer plate configurations.

FIGS. 3A to 3E show examples mixer plate configurations.

FIG. 4 shows an example of a configuration for a reverse flow reactor.

FIGS. 5A to 5E show examples mixer plate configurations.

FIG. 6 shows the thermocouple locations for testing of mixer plate configurations.

FIG. 7 shows temperature differentials between the thermocouple locations shown in FIG. 6 during a cyclic reforming reaction.

FIGS. 8A and 8B show thermocouple locations for testing of additional mixer plate configurations.

FIG. 9 shows temperature differentials between the thermocouple locations shown in FIG. 8A during a cyclic reforming reaction.

FIG. 10 shows temperature differentials between the thermocouple locations shown in FIG. 8B during a cyclic reforming reaction.

FIG. 11 shows an example of a diffuser configuration.

FIG. 12 shows thermocouple locations for testing of an additional mixer location.

FIG. 13 shows temperature differentials between the thermocouple locations shown in FIG. 12.

### DETAILED DESCRIPTION OF THE EMBODIMENTS

All numerical values within the detailed description and the claims herein are modified by “about” or “approximately” the indicated value, and take into account experimental error and variations that would be expected by a person having ordinary skill in the art.

### Overview

In various aspects, systems and methods are provided for improving the flow distribution in the high temperature zone of a cyclic flow reactor, such as a reverse flow reactor. The systems can include a plurality of mixing plates that can facilitate mixing of flows that have been maintained separately until a mixing location. Based in part on the use of a plurality of mixing plates, methods are provided for operating a cyclic flow reactor, such as a reverse flow reactor, with a temperature profile that has improved uniformity across the cross-section of the reactor. In some aspects, a flame diffuser can be included downstream from the plurality of mixing plates to further improve the uniformity of the temperature distribution.

A Reverse Flow Reactor (RFR) is an example of a cyclic flow reactor, where flows introduced into the reactor in roughly opposing directions can be used to create a desirable temperature profile within a reaction environment. In an RFR, heat is efficiently supplied for endothermic reactions, such as reforming, by rapidly cycling with exothermic combustion (a.k.a. regeneration) reactions in the reverse direction. The nature of the RFR reaction environment can provide a variety of advantages in various applications. Such applications can include, but are not limited to, reforming of natural gas to produce blue hydrogen, methane pyrolysis to make acetylene, ethane cracking to produce ethylene, propane dehydrogenation, methane to aromatics production, and other endothermic petrochemical reactions.

Reactors that perform direct heating, such as reverse flow reactors, can potentially allow for improved thermal efficiency when performing endothermic reactions by reducing or minimizing the amount of heat that is lost while trying to transfer heat from an external heating zone to a reaction zone. However, implementing direct heating can present its own challenges. For example, one method for controlling the heating profile in a reactor is to control the location where combustion is initiated. This is typically achieved by maintaining the fuel and oxidant in separate channels or volumes until the respective gas flows reach a position at or near the desired location for starting the combustion reaction. While this is effective for controlling the position of combustion, the fuel and oxidant gas flows have only a limited distance for mixing. In some situations, this can result in uneven levels of combustion across the cross-section of the reactor, leading to a substantial temperature differentials.

For steam methane reforming, higher temperature favors increased H₂ production at equilibrium, but temperatures that are too high can result in sintering and volatilization of the catalyst. As an example, temperatures of roughly 1000° C. or higher can be desirable for performing steam methane reforming in an RFR in order to drive conversion of the methane to greater than 85%. However, prolonged operation at 1150° C. has been determined to result in Ni loss from nickel-based catalysts. If there is substantial variation in temperature across the reactor cross-section, achieving a temperature of 1000° C. for a meaningful portion of the reaction volume while avoiding exposure of parts of the reactor to temperatures of 1150° C. or higher can be challenging. By contrast, if a more uniform radial and angular T distribution can be achieved, this can allow for selection of higher operating temperatures while still avoiding prolonged exposure of reactor internals to temperatures of 1150° C. or higher. It is noted that uniformity can have increased importance at the end of regeneration in which T is highest and 02 is present to convert catalyst metals to their volatile oxide form. Furthermore, the formation of localized hot spots on the catalyst can lead to loss of reforming activity; this activity loss reduces the amount of endothermic reforming happening in the cycle and allows hot spots to spread. Thermal gradients can also crack monoliths due to uneven expansion.

Additional difficulties can arise based on the relative amounts of fuel and oxidant. To reduce or minimize the amount of diluent in the regeneration effluent, the amount of excess 02 is typically reduced or minimized so that only a 10% excess of 02 is present relative to stoichiometric need. This amount is sufficient to burn off coke that may form on the catalysts. Because the regeneration mixture is near stoichiometric, uniform mixing is needed. Flow rate uniformity is also important as this impacts the amount of heat deposited and removed from the catalyst.

In order to improve mixing of the fuel and oxidant flows, mixing plates can be included in the volume where the fuel and oxidant flows are mixed. However, due to the relatively short distance for mixing prior to the initiation of combustion, conventional mixer designs can still allow for substantial temperature differentials across the cross-section of a reactor.

It has been discovered that the temperature differential across the cross-section of a reactor can be reduced or minimized by using a series of mixing plates with an improved combination of mixing plate configurations. The improved combination of mixing plate configurations can include several features. First, at least one plate can assist with introducing rotation into the gas flow passing through the mixing plates. Second, the combination of mixing plates can include at least one plate for focusing the gas flow into the center of the reactor followed by at least one plate for distributing the gas flow toward the edge of the reactor. Third, at least one plate toward the downstream end of the mixing plates (such as the final plate) can be configured for distributing the gas flow toward the edge of the reactor by include openings or flow channels of different diameters. For this at least one plate having openings of different diameters, the openings near the center of the at least one plate can be smaller than the openings near the edge of the at least one plate. This type of at least one plate can be located downstream from an adjacent plate for focusing the gas flow along the center axis of the reactor. This combination of plates can allow the gas flow to be re-distributed efficiently toward the edge of the reactor while still preserving some gas flow at or near the middle of the reactor.

In some aspects, additional benefits can be achieved by also including a flame diffuser downstream from the mixing plates. The diffuser can correspond to a structure with a large plurality of relatively small openings. After achieving improved mixing using the plurality of mixing plates, a flame diffuser can assist with distributing relatively even amounts of gas flow across the full cross-section of the reactor. Diffuser structures can correspond to structures with a large plurality of openings, such as a perforated plate or a mesh-like structure. A diffuser structure can have a thickness similar to the thickness of a mixer plate.

In some aspects, still further additional benefits can be achieved by forming the mixing plates from a suitable material. An example of a suitable material is silicon nitride. Additionally, in some aspects, it can be beneficial to anneal the mixer plates at a sufficiently high temperature prior to exposure to the combustion environment. This can reduce or minimize degradation of the mixer plates during exposure to the combustion environment.

### Definitions

In this discussion, there are several options for characterizing or describing the portion of a mixer plate and/or other mixer structure that is open for entry of the fluid flow into the structure for passage through at least a portion of the structure. One option can be to describe an open frontal area (OFA). For structures that have a large plurality of openings, so that there is roughly a similar amount of open area across the entire cross-section of the structure at the face of the structure where fluid flow enters, the average open frontal area can be used to characterize the structure. The open frontal area is defined based on the cross-sectional area of a structure relative to the axis for gas flow within a reactor. The open frontal area corresponds to the percentage of a structure that is open to allow for entry of a fluid flow. It can be determined, for example, by calculating the total open area for fluid flow for the cross-section of the structure divided by the total cross-sectional area.

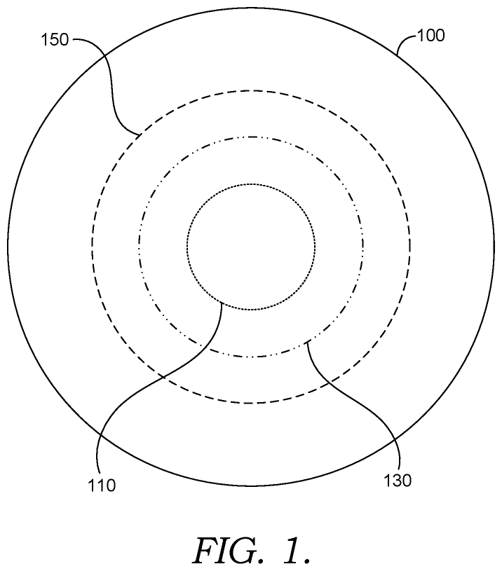

Another option for characterizing the open portion of a structure can be based on the amount of open area for a central portion of the structure versus the amount of open area outside of the central portion. As an example, FIG. 1 shows an outer circle 100 that represents the total cross-sectional area for a mixer element. The dashed circles inside the outer circle represent different dividing lines for defining an inner portion and an outer portion of the cross-sectional area. For example, circle 110 could correspond to a circle defining an inner 10% of the cross-sectional area and an outer 90%. The area inside circle 110 corresponds to the inner 10% while the area outside of circle 110 corresponds to the outer 90%. Similarly, circle 130 could correspond to a circle defining an inner 30% of the cross-sectional area and an outer 70%. Circle 150 could correspond to a circle defining an inner 50% of the cross-sectional area and an outer 50%. Under this type of definition, the “inner” portion of the cross-sectional area always includes the geometric center of an element. By defining an “inner” portion and an “outer” portion, the percentage of open area within the “inner” or “outer” portion can then be defined separately, as opposed to only specifying a single open frontal area that applies to the entire cross-section. It is understood that circles 110, 130, and 150 are representative to illustrate a concept, and the drawing may not necessarily be to correct scale. It is also understood that any other convenient division of the cross-sectional area between an inner portion and an outer portion could be used, such as an inner 70%/outer 30%, or an inner 40%/outer 60%.

The amount of open area in a mixer plate can be selected based on various factors. For example, in some aspects, the open area of a plate can be selected so that there is sufficient open area to reduce or minimize compressibility effects and/or to reduce or minimize pressure drop. This can be achieved, for example, by having the open area be sufficiently large so that the gas velocity through the open area is below a target Mach number, such as having the gas velocity be below 0.1 Mach. As another example, for plates other than the final plate, the open areas of adjacent plates can be selected so that the open area of adjacent plates has an empty intersection. This prevents flow bypassing.

It is noted that although a circular cross-section 100 is shown in FIG. 1, any convenient cross-section can be used that is suitable for use as a reactor cross-section. If a reactor shape with a cross-section different from circular is used, then the “inner” and “outer” portion definitions are based on that different cross-sectional shape. It is noted that the open area in an “inner” or “outer” portion may be symmetric, or it may be randomly distributed.

When characterizing open area within an inner or outer portion, the average size of the openings in the inner portion and/or the outer portion can also be characterized. For example, in some aspects, it can be advantageous to have a mixer plate that allows some gas flow to pass through the inner portion, but to have larger size openings in the outer portion. This can assist with having a higher percentage of open area in the outer portion and/or with otherwise diverting a larger proportion of the flow to the outer portion of the cross-sectional area.

### Mixer Plates

In various aspects, by using a plurality of mixing plates, an improved gas flow pattern within a reactor can be created in a relatively small volume to improve heat distribution from a combustion reaction. To achieve this, a plurality of different types of mixing plates can be used in series. In various aspects, the series of mixing plates can include at least a first plate with primarily open area in an outer portion of the plate; a second plate that includes both mixing vanes and primarily open area in an inner portion of the plate; and a third plate with smaller openings in the inner portion of the plate and with a majority of the open area in an outer portion of the plate.

The mixer plates can have any convenient thickness that provides sufficient structural stability while allowing for openings within the plate. In some aspects, the mixer plates can have a thickness of roughly 1.0-5.0 mm, or 2.0-3.0 mm. The mixer plates can be separated by a relatively small distance, such as 4.0-10 mm, or 5.0-7.0 mm. The mixer plates can be composed of a material that can maintain structural integrity when exposed to elevated temperatures in a combustion environment. Examples of suitable materials can include silicon carbide and silicon nitride. Optionally, the mixer plates can be sintered at high temperature in air prior to use, such as sintering at 1300° C. for 24 hours in air.

In various aspects, the total cross-sectional area of a mixer plate can be substantially the same as the cross-sectional area of the interior of the reactor at the location of the mixer plate. In other words, the cross-sectional area of the mixer plate is sufficiently similar to the size of the interior of the reactor so that little or no bypass of gas flow can occur. Instead, substantially all of the gas flow passes through the open areas of the mixer plate to travel downstream in the reactor.

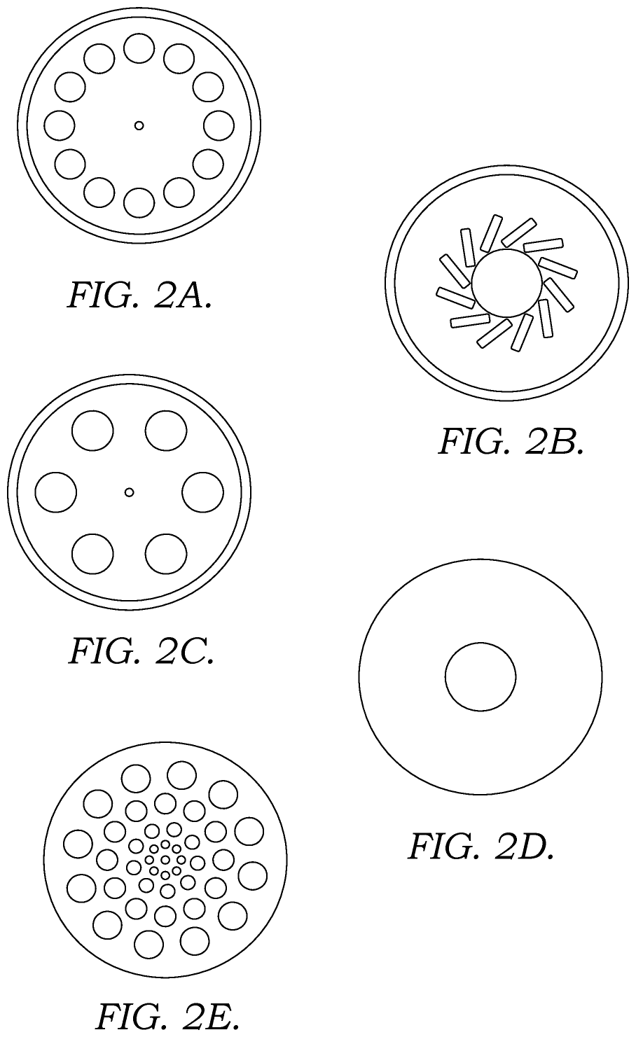

FIGS. 2A-2E show examples of five different types of plates. FIG. 2A shows an example of a type of plate where a majority of the open area is in an outer portion of the plate. In the configuration shown in FIG. 2A, the inner portion corresponds to 20% to 40% of the total cross-sectional area. In the configuration in FIG. 2A, the open area of the inner portion corresponds to 5% or less of the inner portion. The open area of the outer portion can be 30% or more of the outer portion, or 40% or more, or 50% or more, such as up to 70% or possibly still higher.

In FIG. 2A, the open area in the outer portion corresponds to a plurality of openings. The openings can be arranged in any convenient manner. In some aspects the plurality of openings can be uniform and/or symmetric. In other aspects, the openings can be disordered. The size of the openings can be uniform or varied.

FIG. 2B shows an example of a type of plate where a substantial majority of the open area (such as up to all of the open area) is in an inner portion of the plate. Additionally, the plate shown in FIG. 2B includes rotational vanes for introducing rotation or turbulence into a flow to assist with mixing. In the configuration shown in FIG. 2B, the inner portion corresponds to 20% to 40% of the total cross-sectional area. In the configuration in FIG. 2B, the open area of the outer portion corresponds to 5% or less of the outer portion. The open area of the inner portion can be 50% or more of the inner portion, or 60% or more, such as up to 100%. Additionally, the outer portion can include a plurality of mixing vanes arranged around the inner portion for inducing rotation and/or turbulence into the flow as it passed through the open area in the inner portion. In some aspects, one or more of the mixing vanes can be adjacent to the inner portion. In some aspects, where the open area of the inner portion is substantially similar to the area of the inner portion, one or more of the mixing vanes can be adjacent to the open area of the inner portion.

FIG. 2C shows another example of a type of plate where a substantial majority of the open area is in an outer portion of the plate. In FIG. 2C, the open area of the outer portion of the plate is somewhat less than the open area of the outer portion of the plate in FIG. 2A. In the configuration shown in FIG. 2C, the inner portion corresponds to 20% to 40% of the total cross-sectional area. In the configuration in FIG. 2A, the open area of the inner portion corresponds to 5% or less of the inner portion. The open area of the outer portion can be 20% or more of the outer portion, or 30% or more, or 40% or more, such as up to 60% or possibly still higher. In some aspects, the types of plates shown in FIG. 2A or FIG. 2C could be used interchangeably. In some other aspects, FIG. 2C could provide additional benefits when located downstream from a plate such as FIG. 2B, where the open area is substantially concentrated in the inner portion. In some other aspects, FIG. 2A could provide additional benefits when used as a first plate in a series of plates, as the plate in FIG. 2A can start the process of re-directing the gas flow while reducing or minimizing the pressure drop prior to entering the series of mixing plates.

FIG. 2D shows another example of a type of plate where a substantial majority of the open area is in an inner portion of the plate. The plate in FIG. 2D is an example of having a central opening without having the mixing vanes. In the configuration shown in FIG. 2D, the inner portion corresponds to 20% to 40% of the total cross-sectional area. In the configuration in FIG. 2D, the open area of the outer portion corresponds to 5% or less of the outer portion. The open area of the inner portion can be 50% or more of the inner portion, or 60% or more, such as up to 100%.

FIG. 2E shows an example of a type of plate where the open area of the plate is distributed between the inner portion and the outer portion. However, the openings in the plate are not of uniform size. Instead, the outer portion includes larger openings while the inner portion includes smaller openings. In the example shown in FIG. 2E, the openings increase in size moving from the center to the edge of the plate. In other aspects, any convenient size of openings can be used so that the inner portion includes smaller openings than the outer portion. For example, the openings in the inner portion can be of a single size while the openings in the outer portion are of a single larger size. Another option can be to have a gradient of sizes for openings in only one of the inner portion and the outer portion. For the type of plate shown in FIG. 2E, the inner portion can correspond to 20% to 50% of the total cross-sectional area, or 20% to 40%. The open area in the inner portion can correspond to 10% to 50% of the inner portion, or 10% to 40%, or 10% to 30%, or 20% to 50%, or 20% to 40%. The open area in the outer portion can correspond to 20% to 60% of the outer portion, or 20% to 50%, or 20% to 40%, or 30% to 60%, or 30% to 50%.

For a plate where the openings in the outer portion are larger than the openings in the inner portion, the ratio of the average diameters in the outer portion and the inner portion can be any convenient ratio. In some aspects, the ratio of the average diameter for the openings in the outer portion relative to the average diameter of the openings in the inner portion can be 1.5 or more, or 2.0 or more, or 3.0 or more, such as up to 10 or possibly still more.

It is noted that there are several options for determining where the dividing line is between the inner portion and the outer portion. For example, for a first plate (or another plate where a majority of the surface area is in the outer portion), a common configuration is to have either a small central open area or no central open area. In such a configuration, a plurality of openings are distributed away from the center of the plate. In such a configuration, the inner portion can be defined as a) the area inside the largest circle that excludes the plurality of openings distributed away from the center of the plate orb) the area inside a circle containing 40% of the total cross-sectional area of the plate, if the circle defined in a) would contain more than 40% of the total cross-sectional area.

As another example, for a second plate (or another plate where a majority of the open area is in the inner portion), the inner portion can be defined as i) the area inside a circle containing 20% of the total area, ii) if the circle in i) would pass through an open area, the area inside the smallest circle containing between 20% to 40% of the total cross-sectional area, where the circle does not pass through an open area, or iii) a circle containing 40% of the total cross-sectional area, if both i) and ii) cannot be satisfied.

As still another example, for a third plate (or another plate with larger openings in the outer portion), the inner portion can be defined as A) the area inside the smallest circle including between 20% to 40% of the total cross-sectional area that does not pass through an open area, or B) the area inside a circle containing 40% of the total cross-sectional area of the plate, if the circle defined in A) cannot be formed.

It is further noted that for the definitions in a), b), i), ii), iii), A), and B), the definitions are written for plates that will be placed in a reactor having a roughly circular cross-section. If the plates have a non-circular cross-section, instead of using circles in the definitions above, the shape of the plate and/or the shape of the reactor cross-section can be used instead.

In some aspects, in addition to alternating plates with a majority of open area in the outer portion versus the inner portion, the open areas in the plates can be arranged to reduce or minimize overlap between open areas in adjacent (i.e., consecutive) plates. In some aspects, such as for the final plate in a plurality of mixer plates, there can be substantially no overlap between open areas in the outer portion of adjacent plates. Substantially no overlap is defined as having less than 5.0% overlap, or less than 1.0% overlap. Overlap is determined based on overlap along the axis of the reactor. In other aspects, there can be substantially no overlap between any open areas in adjacent plates. In some alternative aspects, a small open area may be present in a plate that is concentric with the central axis of the plate. In such alternative aspects, if the small open area corresponds to 3.0% or less of the total cross-sectional area, the small open area concentric with the central axis can be excluded when determining overlap between adjacent plates. In some alternative aspects, the overlap in open area between the final plate and the adjacent plate can be greater than the open area overlap for other adjacent plates. This additional overlap can facilitate a more beneficial velocity profile as gas exits from the final mixer plate. In such aspects, the overlap in open area between the final plate and the adjacent plate can be 10% or more relative to a total open area of the plurality of outer openings in the final plate, or 25% or more, such as up to 50% or possibly still higher.

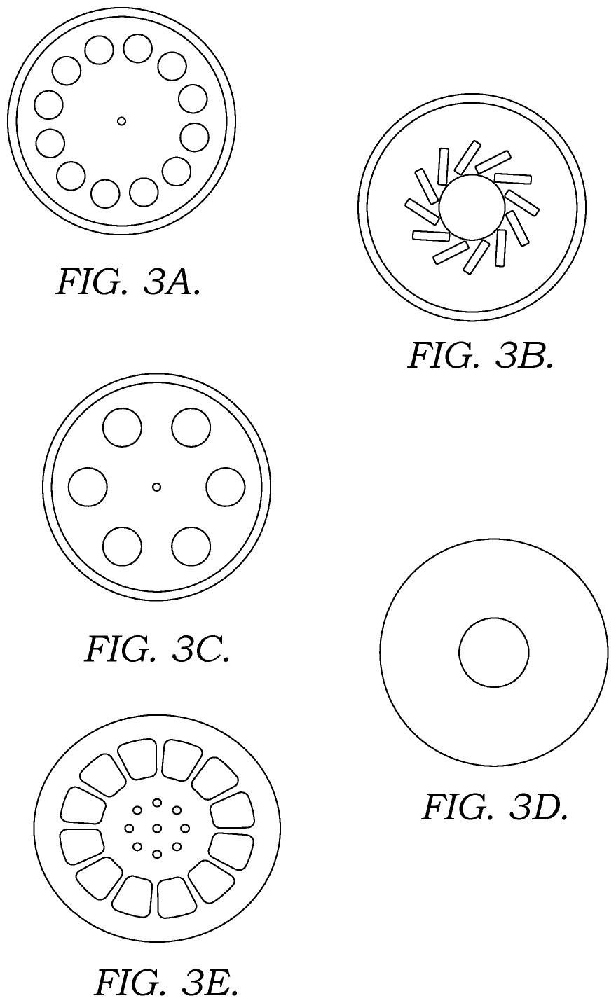

FIG. 2A to FIG. 2E show examples of mixer plates where the openings in the plates are uncovered. FIG. 3A to FIG. 3E show examples of mixer plates where at least some openings on some plates have diffusion covers over the openings. Such diffusion covers can further aid in mixing of the gas flow by reducing or minimizing the ability of a gas flow to pass directly through an opening. The plate configurations in FIG. 3A to FIG. 3E are generally similar to the corresponding configurations in FIG. 2A to FIG. 2E, but FIG. 3C, FIG. 3D, and FIG. 3E include diffusion covers over at least a portion of the open area. In FIG. 3C and FIG. 3E, diffusions covers are in place over the open areas in the outer portion of the mixer plate. In FIG. 3D, a diffusion cover is in place over the open area in the inner portion. It is noted that the diffusion covers are mounted above the level of the plate surface, so that the gas flow can pass under the diffusion cover in order to pass through the opening.

A plurality of mixing plates in series can be used to assist with mixing an oxygen-containing gas with a fuel-containing gas to provide improved temperature uniformity in a combustion reaction. In various aspects, the plurality of mixing plates can include at least a first plate where a majority of the open area is in an outer portion of the plate; a second plate where a majority of the open area is in an inner portion of the plate, where the second plate also incorporates mixing vanes; and a third plate where a majority of the open area is in an outer portion of the plate. For example, in some aspects, a plurality of mixing plates can correspond to a sequence where a first plate has a configuration similar to the plate configuration in FIG. 2A, FIG. 2C, FIG. 3A, or FIG. 3C. In such an aspect, a second plate can have a configuration similar to the plate configuration in FIG. 2B or FIG. 3B. In such an aspect, a third plate can have a configuration similar to the plate configuration in FIG. 2E or FIG. 3E. It is noted that other plates can be included in the plurality of plates, including plates that are between the first plate and second plate or plates between the second plate and third plate, so long as the sequence of alternating a plate with a majority of area in an outer portion and a plate with a majority of area in an inner portion is maintained. Thus, a configuration including the plates in FIG. 2A, FIG. 2B, and FIG. 2E can be used. Another possible configuration is to use the sequence of plates shown in FIGS. 2A-2E, so that the plates from FIG. 2C and FIG. 2D are inserted between the plate shown in FIG. 2B and the plate shown in FIG. 2E.

In some aspects, in addition to the plurality of mixing plates, a diffuser can be included after the final plate. The diffuser can further assist with distributing the gas flow in a more uniform manner.

### Examples of Reverse Flow Reactor Configuration

For endothermic reactions operated at elevated temperatures, such as hydrocarbon reforming, a reverse flow reactor can provide a suitable reaction environment for providing the heat for the endothermic reaction.

In a reverse flow reactor, the heat needed for an endothermic reaction may be provided by creating a high-temperature heat bubble in the middle of the reactor. A two-step process can then be used wherein heat is (a) added to the reactor bed(s) or monolith(s) via in-situ combustion, and then (b) removed from the bed in-situ via an endothermic process, such as reforming, pyrolysis, or steam cracking. This type of configuration can provide the ability to consistently manage and confine the high temperature bubble in a reactor region(s) that can tolerate such conditions long term. A reverse flow reactor system can allow the primary endothermic and regeneration processes to be performed in a substantially continuous manner.

A reverse flow reactor system can include first and second reactors, oriented in a series relationship with each other with respect to a common flow path, and optionally but preferably along a common axis. The common axis may be horizontal, vertical, or otherwise. During a regeneration step, reactants (e.g., fuel and oxygen) are permitted to combine or mix in a reaction zone to combust therein, in-situ, and create a high temperature zone or heat bubble inside a middle portion of the reactor system. The heat bubble can correspond to a temperature that is at least about the initial temperature for the endothermic reaction. Typically, the temperature of the heat bubble can be greater than the initial temperature for the endothermic reaction, as the temperature will decrease as heat is transferred from the heat bubble in a middle portion of the reactor toward the ends of the reactor. In some aspects, the combining can be enhanced by a reactant mixer that mixes the reactants to facilitate substantially complete combustion/reaction at the desired location, with the mixer optionally located between the first and second reactors. The combustion process can take place over a long enough duration that the flow of first and second reactants through the first reactor also serves to displace a substantial portion, (as desired) of the heat produced by the reaction (e.g., the heat bubble), into and at least partially through the second reactor, but preferably not all of the way through the second reactor to avoid waste of heat and overheating the second reactor. The flue gas may be exhausted through the second reactor, but preferably most of the heat is retained within the second reactor. The amount of heat displaced into the second reactor during the regeneration step can also be limited or determined by the desired exposure time or space velocity that the hydrocarbon feed gas will have in the endothermic reaction environment.

After regeneration or heating of the second reactor media, in the next/reverse step or cycle, reactants for the endothermic reaction methane (and/or natural gas and/or another hydrocarbon) can be supplied or flowed through the second reactor, from the direction opposite the direction of flow during the heating step. For example, in a reforming process, methane (and/or natural gas and/or another hydrocarbon) can be supplied or flowed through the second reactor. The methane can contact the hot second reactor and mixer media, in the heat bubble region, to transfer the heat to the methane for reaction energy.

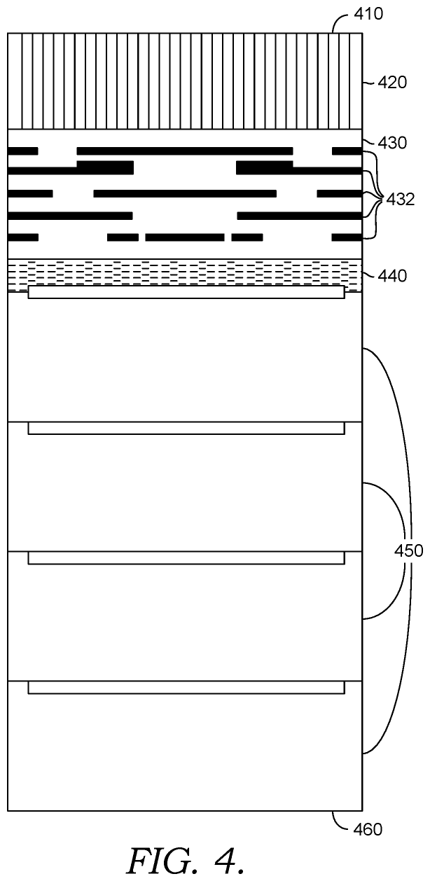

FIG. 4 shows an example of a configuration for a reverse flow reactor. In FIG. 4, section 420 of the reactor corresponds to a recuperator zone, while section 450 corresponds to a reaction zone. It is noted that FIG. 4 is described as a single reactor, but the configuration could alternatively be described with section 420 corresponding to a first recuperation reactor and section 450 corresponding to a second reactor for reforming (or another endothermic process). A mixer zone 430 roughly corresponds to the interface between reaction zone 450 and recuperator zone 420. In the example shown in FIG. 4, mixer zone 430 includes a plurality of mixing plates 432 as well as a flame diffuser 440. The example shown in FIG. 4 also includes distributor plates 410 and 460 at opposing ends of the reactor. To facilitate description, the reactor in FIG. 4 is described herein with reference to a reforming reaction. It is understood that other convenient types of endothermic reactions can generally be performed using a reverse flow reactor.

The configuration shown in FIG. 4 can be used to illustrate the basic two-step asymmetric cycle of a reverse flow regenerative bed reactor system. Both the reaction zone 450 and the recuperator zone 420 can contain regenerative monoliths and/or other regenerative structures. Regenerative monoliths or other regenerative structures, as used herein, comprise materials that are effective in storing and transferring heat as well as being effective for carrying out a chemical reaction. The regenerative monoliths and/or other structures can correspond to any convenient type of material that is suitable for storing heat, transferring heat, and catalyzing a reaction. Examples of structures can include bedding or packing material, ceramic beads or spheres, ceramic honeycomb materials, ceramic tubes, extruded monoliths, and the like, provided they are competent to maintain integrity, functionality, and withstand long term exposure to temperatures in excess of 1200° C., or in excess of 1400° C., or in excess of 1600° C., which can allow for some operating margin.

At the beginning of the “reaction” step of the cycle, the portion of the reaction zone 450 near mixing zone 430 can be at an elevated temperature as compared to the end near distributor plate 460. At the beginning of such a reaction step, at least a portion of the recuperation zone 420, including the end near distributor plate 410, can be at a lower temperature than the reaction zone 450 to provide a quenching effect for the resulting product. In an aspect where the reactors are used to perform reverse flow reforming, a methane-containing reactant feed (or other hydrocarbon-containing reactant feed) can be introduced into the reaction zone 450 at or near the end of the reaction zone that is adjacent to distributor plate 460. In various aspects, the hydrocarbon-containing reactant feed can also contain H₂O, CO₂, or a combination thereof.

The reforming feed can absorb heat from reaction zone 450 and endothermically react to produce the desired synthesis gas product. As this step proceeds, a shift in the temperature profile can be created based on the heat transfer properties of the system. When the ceramic catalyst monolith/other catalyst structure is designed with adequate heat transfer capability, this profile can have a relatively sharp temperature gradient, which gradient can move across the reaction zone 450 as the reforming step proceeds. In some aspects, a sharper temperature gradient profile can provide for improved control over reaction conditions. In aspects where another type of endothermic reaction is performed, a similar shift in temperature profile can occur, so that a temperature gradient moves across reaction zone 450 as the reaction step proceeds.

The effluent from the reforming reaction, which can include unreacted feed components (hydrocarbons, H₂O, CO₂) as well as synthesis gas components, can exit the reaction zone 450 at an elevated temperature and pass through the recuperation zone 420. The recuperation zone can initially be at a lower temperature than the reaction zone 450. As the products (and optionally unreacted feed) from the reforming reaction pass through the recuperation zone 420, the gas can be quenched or cooled. As the reforming effluent is cooled in the recuperation zone, a temperature gradient can be created in the zone's regenerative bed(s) and can move across the recuperation zone 450 during this step. The quenching can heat the recuperation zone 450, which can be cooled again in the second step to later provide another quenching service and to prevent the size and location of the heat bubble from growing progressively. After quenching, the reaction gas can exit the recuperation zone 450 and can be processed for separation and recovery of the various components.

The second step of the cycle, referred to as the regeneration step, can then begin with introduction of the first and second regeneration reactants (i.e., fuel flow and oxygen-containing flow) into the reactor. Although both the fuel flow and the oxygen-containing flow are introduced as part of the regeneration step, the fuel flow and oxygen containing flow are maintained substantially separate until the flows are allowed to mix at or near the interface between recuperation zone 420 and mixing zone 430. This can be achieved in any convenient manner. For example, a first flow (either the fuel flow or the oxygen-containing flow) can be introduced into the main volume of the recuperation zone 420 to allow the flow to be heated using the heat recovered during the prior reaction step. The second flow that was not introduced into the main volume of the recuperation zone can be introduced into the reactor via separate channels. If the separate channels pass through the recuperation zone, some heat transfer to the separate channels may occur. Alternatively, the channels may be thermally isolated from the recuperation zone, or may only pass through the recuperation zone in a minimal amount so that the two flows are initially combined at or near the beginning of the mixer zone 430.

In various aspects, after maintaining the fuel and oxidant in separate channels or volumes, the fuel and oxidant can be combined at or near the location of a plurality of mixing plates. The combined fuel and oxidant flow then passes through the series of mixing plates to facilitate mixing, allowing for improvements in the uniformity of the temperature profile that results from the combustion reaction.

During the regeneration step, temperature gradients can also move through the recuperation zone and the reaction zone. During regeneration, the recuperation zone is cooled as heat from the recuperation zone is transferred to the incoming gas flow(s). After combining the gas flows, a combustion reaction is initiated which can produce a region of high temperature at or near the location where the combustion reaction is initiated. This location can be within the mixing zone or within the reaction zone. After combustion is complete, the resulting gas flow containing combustion products continues through the reaction zone and carries heat from the combustion location downstream to other portions of the reaction zone. This can provide a temperature gradient that moves downstream through the reaction zone.

### Process Example—Reverse Flow Reforming and Regeneration

In various aspects, reforming of hydrocarbons can be performed under steam reforming conditions in the presence of H₂O, under dry reforming conditions in the presence of CO₂, or under conditions where both H₂O and CO₂ are present in the reaction environment. As a general overview of operation during reforming in a swing reactor, such as a reverse flow reactor, a regeneration step or portion of a reaction cycle can be used to provide heat for the reactor. Reforming can then occur within the reactor during a reforming step or portion of the cycle, with the reforming reaction consuming heat provided during the reactor regeneration step. During reactor regeneration, fuel and an oxidant are introduced into the reactor from a regeneration end of the reactor. The bed and/or monoliths in the regeneration portion of the reactor can absorb heat, but typically do not include a catalyst for reforming. As the fuel and oxidant pass through the regeneration section, heat is transferred from the regeneration section to the fuel and oxidant. Combustion does not occur immediately, but instead the location of combustion is controlled to occur in a middle portion of the reactor. The flow of the reactants continues during the regeneration step, leading to additional transfer of the heat generated from combustion into the reforming end of the reactor.

After a sufficient period of time, the combustion reaction is stopped. Any remaining combustion products and/or reactants can optionally be purged. The reforming step or portion of the reaction cycle can then start. The reactants for reforming can be introduced into the reforming end of the reactor, and thus flow in effectively the opposite direction relative to the flow during regeneration. The bed and/or monoliths in the reforming portion of the reactor can include a catalyst for reforming. In various aspects, at least a portion of the catalyst can correspond to a catalyst formed from a ceramic composition as described herein. As reforming occurs, the heat introduced into the reforming zone during combustion can be consumed by the endothermic reforming reaction. After exiting the reforming zone, the reforming products (and unreacted reactants) are no longer exposed to a reforming catalyst. As the reforming products pass through the regeneration zone, heat can be transferred from the products to the regeneration zone. After a sufficient period of time, the reforming process can be stopped, remaining reforming products can optionally be collected or purged from the reactor, and the cycle can start again with a regeneration step.

The reforming reaction performed within the reactor can correspond reforming of methane and/or other hydrocarbons using steam reforming, in the presence of H₂O; using dry reforming, in the presence of CO₂, or using “bi” reforming in the presence of both H₂O and CO₂. Examples of stoichiometry for steam, dry, and “bi” reforming of methane are shown in equations (1)-(3).

Dry Reforming:CH₄+CO₂=2CO+2H₂ (1)

Steam Reforming:CH₄+H₂O=CO+3H₂ (2)

Bi Reforming:3CH₄+2H₂O+CO₂=4CO+8H₂. (3)

As shown in equations (1)-(3), dry reforming can produce lower ratios of H₂ to CO than steam reforming. Reforming reactions performed with only steam can generally produce a ratio of H₂ to CO of around 3, such as 2.5 to 3.5. By contrast, reforming reactions performed in the presence of CO₂ can generate much lower ratios, possibly approaching a ratio of H₂ to CO of roughly 1.0 or even lower. By using a combination of CO₂ and H₂O during reforming, the reforming reaction can potentially be controlled to generate a wide variety of H₂ to CO ratios in a resulting syngas.

It is noted that the ratio of H₂ to CO in a synthesis gas can also be dependent on the water gas shift equilibrium. Although the above stoichiometry shows ratios of roughly 1 or roughly 3 for dry reforming and steam reforming, respectively, the equilibrium amounts of H₂ and CO in a synthesis gas can be different from the reaction stoichiometry. The equilibrium amounts can be determined based on the water gas shift equilibrium, which relates the concentrations of H₂, CO, CO₂ and H₂O based on the reaction

H₂O+CO<=>H₂+CO₂ (4)

Most reforming catalysts, such as rhodium and/or nickel, can also serve as water gas shift catalysts. Thus, if reaction environment for producing H₂ and CO also includes H₂O and/or CO₂, the initial stoichiometry from the reforming reaction may be altered based on the water gas shift equilibrium. This equilibrium is also temperature dependent, with higher temperatures favoring production of CO and H₂O. It is noted that higher temperatures can also improve the rate for reaching equilibrium. As a result, the ability to perform a reforming reaction at elevated temperatures can potentially provide several benefits. For example, instead of performing steam reforming in an environment with excess H₂O, CO₂ can be added to the reaction environment. This can allow for both a reduction in the ratio of H₂ to CO produced based on the dry reforming stoichiometry as well as a reduction in the ratio of H₂ to CO produced based on the water gas shift equilibrium. Alternatively, if a higher H₂ to CO ratio is desired, CO₂ can be removed from the environment, and the ratio of H₂O to CH₄ (or other hydrocarbons) can be controlled to produce a desirable type of synthesis gas. This can potentially allow for generation of a synthesis gas having a H₂ to CO ratio of 0.1 to 15, or 0.1 to 3.0, or 0.5 to 5.0, or 1.0 to 10, by selecting appropriate amounts of feed components.

The reforming reactions shown in equations (1)-(3) are endothermic reactions. One of the challenges in commercial scale reforming can be providing the heat for performing the reforming reaction in an efficient manner while reducing or minimizing introduction of additional components into the desired synthesis gas product. Cyclic reaction systems, such as reverse flow reactor systems, can provide heat in a desirable manner by having a cycle including a reforming step and a regeneration step. During the regeneration step, combustion can be performed within a selected area of the reactor. A gas flow during regeneration can assist with transferring this heat from the combustion zone toward additional portions of the reforming zone in the reactor. The reforming step within the cycle can be a separate step, so that incorporation of products from combustion into the reactants and/or products from reforming can be reduced or minimized. The reforming step can consume heat, which can reduce the temperature of the reforming zone. As the products from reforming pass through the reactor, the reforming products can pass through a second zone that lacks a reforming or water gas shift catalyst. This can allow the reaction products to cool prior to exiting the reactor. The heat transferred from the reforming products to the reactor can then be used to increase the temperature of the reactants for the next combustion or regeneration step.

One common source for methane is natural gas. In some applications, natural gas, including associated hydrocarbon and impurity gases, may be used as a feed for the reforming reaction. The supplied natural gas also may be sweetened and/or dehydrated natural gas. Natural gas commonly includes various concentrations of associated gases, such as ethane and other alkanes, preferably in lesser concentrations than methane. The supplied natural gas may include impurities, such as H₂S and nitrogen. More generally, the hydrocarbon feed for reforming can include any convenient combination of methane and/or other hydrocarbons. Optionally, the reforming feed may also include some hydrocarbonaceous compounds, such as alcohols or mercaptans, which are similar to hydrocarbons but include one or more heteroatoms different from carbon and hydrogen. In some aspects, an additional component present in the feed can correspond to impurities such as sulfur that can adsorb to the catalytic monolith during a reducing cycle (such as a reforming cycle). Such impurities can be oxidized in a subsequent cycle to form sulfur oxides, which can then be reduced to release additional sulfur-containing components (or other impurity-containing components) into the reaction environment.

In some aspects, the feed for reforming can include, relative to a total weight of hydrocarbons in the feed for reforming, 5 wt % or more of C₂₊ compounds, such as ethane or propane, or 10 wt % or more, or 15 wt % or more, or 20 wt % or more, such as up to 50 wt % or possibly still higher. It is noted that nitrogen and/or other gases that are non-reactive in a combustion environment, such as H₂O and CO₂, may also be present in the feed for reforming. In aspects where the reformer corresponds to an on-board reforming environment, such non-reactive products can optionally be introduced into the feed, for example, based on recycle of an exhaust gas into the reformer. Additionally or alternately, the feed for reforming can include 40 wt % or more methane, or 60 wt % or more, or 80 wt % or more, or 95 wt % or more, such as having a feed that is substantially composed of methane (98 wt % or more). In aspects where the reforming corresponds to steam reforming, a molar ratio of steam molecules to carbon atoms in the feed can be 0.3 to 4.0. It is noted that methane has 1 carbon atom per molecule while ethane has 2 carbon atoms per molecule. In aspects where the reforming corresponds to dry reforming, a molar ratio of CO₂ molecules to carbon atoms in the feed can be 0.05 to 3.0.

Within the reforming zone of a reverse flow reactor, the temperature can vary across the zone due to the nature of how heat is added to the reactor and/or due to the kinetics of the reforming reaction. The highest temperature portion of the zone can typically be found near a middle portion of the reactor. This middle portion can be referred to as a mixing zone where combustion is initiated during regeneration. At least a portion of the mixing zone can correspond to part of the reforming zone if a monolith with reforming catalyst extends into the mixing zone. As a result, the location where combustion is started during regeneration can typically be near to the end of the reforming zone within the reactor. Moving from the center of the reactor to the ends of the reactor, the temperature can decrease. As a result, the temperature at the beginning of the reforming zone (at the end of the reactor) can be cooler than the temperature at the end of the reforming zone (in the middle portion of the reactor).

As the reforming reaction occurs, the temperature within the reforming zone can be reduced. The rate of reduction in temperature can be related to the kinetic factors of the amount of available hydrocarbons for reforming and/or the temperature at a given location within the reforming zone. As the reforming feed moves through the reforming zone, the reactants in the feed can be consumed, which can reduce the amount of reforming that occurs at downstream locations. However, the increase in the temperature of the reforming zone as the reactants move across the reforming zone can lead to an increased reaction rate.

At roughly 500° C., the reaction rate for reforming can be sufficiently reduced that little or no additional reforming will occur. As a result, in some aspects as the reforming reaction progresses, the beginning portion of the reforming zone can cool sufficiently to effectively stop the reforming reaction within a portion of the reforming zone. This can move the location within the reactor where reforming begins to a location that is further downstream relative to the beginning of the reforming zone. When a sufficient portion of the reforming zone has a temperature below 500° C., or below 600° C., the reforming step within the reaction cycle can be stopped to allow for regeneration. Alternatively, based on the amount of heat introduced into the reactor during regeneration, the reforming portion of the reaction cycle can be stopped based on an amount of reaction time, so that the amount of heat consumed during reforming (plus heat lost to the environment) is roughly in balance with the amount of heat added during regeneration. After the reforming process is stopped, any remaining synthesis gas product still in the reactor can optionally be recovered prior to starting the regeneration step of the reaction cycle.

The regeneration process can then be initiated. During regeneration, a fuel such as methane, natural gas, or H₂, and oxygen can be introduced into the reactor and combusted. The location where the fuel and oxidant are allowed to mix can be controlled in any convenient manner, such as by introducing the fuel and oxidant via separate channels. By delaying combustion during regeneration until the reactants reach a central portion of the reactor, the non-reforming end of the reactor can be maintained at a cooler temperature. This can also result in a temperature peak in a middle portion of the reactor. The temperature peak can be located within a portion of the reactor that also includes the reforming catalyst. During a regeneration cycle, the temperature within the reforming reactor can be increased sufficiently to allow for the reforming during the reforming portion of the cycle. This can result in a peak temperature within the reactor of 1100° C. or more, or 1200° C. or more, or 1300° C. or more, or potentially a still higher temperature.

The relative length of time and reactant flow rates for the reforming and regeneration portions of the process cycle can be selected to balance the heat provided during regeneration with the heat consumed during reforming. For example, one option can be to select a reforming step that has a similar length to the regeneration step. Based on the flow rate of hydrocarbons, H₂O, and/or CO₂ during the reforming step, an endothermic heat demand for the reforming reaction can be determined. This heat demand can then be used to calculate a flow rate for combustion reactants during the regeneration step. Of course, in other aspects the balance of heat between reforming and regeneration can be determined in other manners, such as by determining desired flow rates for the reactants and then selecting cycle lengths so that the heat provided by regeneration balances with the heat consumed during reforming.

In addition to providing heat, the reactor regeneration step during a reaction cycle can also allow for coke removal from the catalyst within the reforming zone. In various aspects, one or more types of catalyst regeneration can potentially occur during the regeneration step. One type of catalyst regeneration can correspond to removal of coke from the catalyst. During reforming, a portion of the hydrocarbons introduced into the reforming zone can form coke instead of forming CO or CO₂. This coke can potentially block access to the catalytic sites (such as metal sites) of the catalyst. In some aspects, the rate of formation can be increased in portions of the reforming zone that are exposed to higher temperatures, such as portions of the reforming zone that are exposed to temperatures of 800° C. or more, or 900° C. or more, or 1000° C. or more. During a regeneration step, oxygen can be present as the temperature of the reforming zone is increased. At the temperatures achieved during regeneration, at least a portion of the coke generated during reforming can be removed as CO or CO₂.

Due to the variation in temperature across the reactor, several options can be used for characterizing the temperature within the reactor and/or within the reforming zone of the reactor. One option for characterizing the temperature can be based on an average bed or average monolith temperature within the reforming zone. In practical settings, determining a temperature within a reactor requires the presence of a measurement device, such as a thermocouple. Rather than attempting to measure temperatures within the reforming zone, an average (bed or monolith) temperature within the reforming zone can be defined based on an average of the temperature at the beginning of the reforming zone and a temperature at the end of the reforming zone. Another option can be to characterize the peak temperature within the reforming zone after a regeneration step in the reaction cycle. Generally, the peak temperature can occur at or near the end of the reforming zone, and may be dependent on the location where combustion is initiated in the reactor. Still another option can be to characterize the difference in temperature at a given location within the reaction zone at different times within a reaction cycle. For example, a temperature difference can be determined between the temperature at the end of the regeneration step and the temperature at the end of the reforming step. Such a temperature difference can be characterized at the location of peak temperature within the reactor, at the entrance to the reforming zone, at the exit from the reforming zone, or at any other convenient location.

In various aspects, the reaction conditions for reforming hydrocarbons can include one or more of an average reforming zone temperature ranging from 400° C. to 1200° (or more); a peak temperature within the reforming zone of 800° C. to 1500° C.; a temperature difference at the location of peak temperature between the end of a regeneration step and the end of the subsequent reforming step of 25° C. or more, or 50° C. or more, or 100° C. or more, or 200° C. or more, such as up to 800° C. or possibly still higher; a temperature difference at the entrance to the reforming zone between the end of a regeneration step and the end of the subsequent reforming step of 25° C. or more, or 50° C. or more, or 100° C. or more, or 200° C. or more, such as up to 800° C. or possibly still higher; and/or a temperature difference at the exit from the reforming zone between the end of a regeneration step and the end of the subsequent reforming step of 25° C. or more, or 50° C. or more, or 100° C. or more, or 200° C. or more, such as up to 800° C. or possibly still higher. For example, the temperature difference between the end of the regeneration step and the end of the reforming step at the location of peak temperature and/or at the entrance to the reforming zone can be 80° C. to 220° C., or 80° C. to 160° C., or 100° C. to 220° C., or 100° C. to 160° C., or 120° C. to 220° C., or 120° C. to 160° C.

With regard to the average reforming zone temperature, in various aspects the average temperature for the reforming zone can be 500° C. to 1500° C., or 400° C. to 1200° C., or 800° C. to 1200° C., or 400° C. to 900° C., or 600° C. to 1100° C., or 500° C. to 1000° C. Additionally or alternately, with regard to the peak temperature for the reforming zone (likely corresponding to a location in the reforming zone close to the location for combustion of regeneration reactants), the peak temperature can be 800° C. to 1500° C., or 1000° C. to 1400° C., or 1200° C. to 1500° C., or 1200° C. to 1400° C.

Additionally or alternately, the reaction conditions for reforming hydrocarbons can include a pressure of 0 psig to 1500 psig (10.3 MPa), or 0 psig to 1000 psig (6.9 MPa), or 0 psig to 550 psig (3.8 MPa); and a gas hourly space velocity of reforming reactants of 1000 hr⁻¹ to 50,000 hr⁻¹. The space velocity corresponds to the volume of reactants relative to the volume of monolith per unit time. The volume of the monolith is defined as the volume of the monolith as if it was a solid cylinder.

In some aspects, an advantage of operating the reforming reaction at elevated temperature can be the ability to convert substantially all of the methane and/or other hydrocarbons in a reforming feed. For example, for a reforming process where water is present in the reforming reaction environment (i.e., steam reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %

In other aspects, for a reforming process where carbon dioxide is present in the reforming reaction environment (i.e., dry reforming or bi-reforming), the reaction conditions can be suitable for conversion of 10 wt % to 100 wt % of the methane in the reforming feed, or 20 wt % to 80 wt %, or 50 wt % to 100 wt %, or 80 wt % to 100 wt %, or 10 wt % to 98 wt %, or 50 wt % to 98 wt %. Additionally or alternately, the reaction conditions can be suitable for conversion of 10 wt % to 100 wt % of the hydrocarbons in the reforming feed, or 20 wt % to 80 wt %, or 50 wt % to 100 wt %, or 80 wt % to 100 wt %, or 10 wt % to 98 wt %, or 50 wt % to 98 wt %.

In some alternative aspects, the reforming reaction can be performed under dry reforming conditions, where the reforming is performed with CO₂ as a reagent but with a reduced or minimized amount of H₂O in the reaction environment. In such alternative aspects, a goal of the reforming reaction can be to produce a synthesis gas with a H₂ to CO ratio of 1.0 or less. In some aspects, the temperature during reforming can correspond to the temperature ranges described for steam reforming. Optionally, in some aspects a dry reforming reaction can be performed at a lower temperature of between 500° C. to 700° C., or 500° C. to 600° C. In such aspects, the ratio of H₂ to CO can be 0.3 to 1.0, or 0.3 to 0.7, or 0.5 to 1.0. Performing the dry reforming reaction under these conditions can also lead to substantial coke production, which can require removal during regeneration in order to maintain catalytic activity.

### Monolith Structure(s) for Supporting Catalyst System

One of the purposes of using a monolith or another supporting structure within a reforming environment is to increase the available surface area for holding a deposited catalyst/catalyst system. To achieve this, some monoliths correspond to a structure with a large plurality of cells or channels that allow gas flow through the monolith. Because each individual cell provides surface area for deposition of catalyst, including a large number of cells or channels per unit area can substantially increase the available surface area for catalyst. Such monoliths can generally be referred to as honeycomb monoliths. It is noted that the terms “cell” and “channel” can be used interchangeably to refer to the passages through a monolith.

In various aspects, a monolith or other structure for providing a surface for the reforming catalyst system may be prepared by manufacturing techniques such as but not limited to conventional ceramic powder manufacturing and processing techniques, e.g., mixing, milling, degassing, kneading, pressing, extruding, casting, drying, calcining, and sintering. The starting materials can correspond to a suitable ceramic powder such as synthetic alumina powder and naturally occurring minerals (e.g. bauxite, bentonite, talc) and an organic binder powder in a suitable volume ratio. Certain process steps may be controlled or adjusted to obtain the desired grain size and porosity range and performance properties, such as by inclusion of various manufacturing, property adjusting, and processing additives and agents as are generally known in the art. For example, the two or more types of oxide powders may be mixed in the presence of an organic binder and one or more appropriate solvents or water for a time sufficient to substantially disperse the powders in each other. As another example, precursors of the oxides present in a monolith may be dissolved in water at a desired ratio, spray dried, and calcined to make a mixed powder. Such precursors include (but are not limited to) chlorides, sulfates, nitrates, and mixtures thereof. The calcined powder can be further mixed in the presence of an organic binder and appropriate solvent(s) to make a mixed “dough”. Then, the mixed “dough” of materials can be placed in a kneader to mix all the ingredient and to enhance plasticity of the mixed “dough”.

The number of kneading times and kneading speed can be adjusted. The kneaded “dough” can be placed in a die or form, extruded, dried or otherwise formed into a desired shape. As a non-limiting example, a screw type extruder can be used, and rotation speed of top and bottom screw can be controlled to form a honeycomb shape. As it produces, a wire cutter attached in the screw type extruder operates to make a desired height of the honeycomb monoliths. The resulting extruded body can then be dried to form a “green body”. As a non-limiting example, hot air dryer can be used to slowly remove the residual solvent or water in the extruded body. Yet another non-limiting example, a standalone microwave oven or even a continuous microwave drying oven can be used to form a “green body”. Drying in a microwave oven is advantageous since it shortens total drying time and minimizes potential cracking associated with a rather rapid drying process. The resulting “green body” can then be sintered at temperatures in the range of about 1500° C.˜1700° C. for at least ten minutes, such as from 10 minutes to 48 hours, or possibly from 10 minutes up to 10 days or still longer. Either a batch furnace or a continuous tunnel kiln can be used to sinter the “green body”. During sintering the “green body” shrinks as it densifies and consolidates. The sintering shrinkage is typically about 2030%.

The sintering operation may be performed in an oxidizing atmosphere, reducing atmosphere, or inert atmosphere, and at ambient pressure or under vacuum. For example, the oxidizing atmosphere could be air or oxygen, the inert atmosphere could be argon, and a reducing atmosphere could be hydrogen, CO/CO₂ or H₂/H₂O mixtures. Thereafter, the sintered body is allowed to cool, typically to ambient conditions. The cooling rate may also be controlled to provide a desired set of grain and pore structures and performance properties in the particular component.

In some aspects, improved durability for a monolith structure can be achieved based on the composition used to form the monolith. In various aspects, the monolith can be composed primarily of alumina (Al₂O₃). It is noted that due to the high temperature of the sintering used for forming the monolith, the alumina in the monolith can typically be in the form of α-Al₂O₃. In addition to alumina, the monolith composition can also include at least 3.0 wt % of silica (SiO₂). The addition of silica to the alumina can enable manufacturing of honeycomb monolith structures using conventional manufacturing methods such as extrusion. When the silica content falls below 3.0 wt %, it is difficult to extrude or otherwise form desired monolith shapes. More generally, the monolith composition can contain at least 3.0 wt % silica, between 3.0 wt % to 9.0 wt % combined of primary dopant oxides, and 1.5 wt % or less of auxiliary and/or contaminant dopant oxides, with the balance of the composition corresponding to alumina. In some aspects, the monolith composition can contain 3.0 wt % to 9.0 wt % of primary dopant oxides, or 3.0 wt % to 8.0 wt %, or 3.0 wt % to 6.5 wt %, or 4.0 wt % to 9.0 wt %, or 4.0 wt % to 8.0 wt %, or 4.0 wt % to 6.5 wt %. Additionally or alternately, the monolith composition can contain 3.0 wt % to 9.0 wt % of silica, or 3.0 wt % to 8.0 wt %, or 3.0 wt % to 6.5 wt %, or 4.0 wt % to 9.0 wt %, or 4.0 wt % to 8.0 wt %, or 4.0 wt % to 6.5 wt %. Further additionally or alternately, the monolith composition can contain 1.5 wt % or less of auxiliary and/or contaminant dopant oxides, or 1.0 wt % or less, or 0.7 wt % or less, or 0.5 wt % or less, such as down to substantially not containing auxiliary and/or contaminant oxides (0.1 wt % or less). Based on these values, the alumina content of the monolith can be 89.5 wt % to 97 wt %, or 91 wt % to 97 wt %, or 93 wt % to 97 wt %, or 89.5 wt % to 95 wt %.

The primary dopant oxides are SiO₂, MgO, CaO, TiO₂, ZrO₂, HfO₂, and Y₂O₃, and combinations thereof. It is noted that silica is always present in the composition in an amount of at least 3.0 wt %, so when other primary dopant oxides different than silica are present, it will be in the form of a combination of at least two oxides (silica plus at least one other oxide). The auxiliary or contaminant oxides represent additional oxides that may be present, but that typically are present due to use of a lower purity source of alumina, silica, and/or another primary dopant. For example, bauxite ore contains alumina and silica, but can also contain other oxides. If the monolith composition is formed in part using an ore such as bauxite, the auxiliary oxides may be present. The amount of auxiliary oxides and/or contaminant oxides is limited to 1.5 wt % or less, or 1.0 wt % or less, as the auxiliary oxides can tend to form a glassy grain boundary phase in combination with silica and/or other dopant oxides. Such a glassy grain boundary phase represents an interface region with reduced durability under high-temperature cyclic conditions since it acts as an easy pass way for crack propagation and results in inter-granular fracture. Limiting the amount of auxiliary oxides can reduce or minimize the formation of such boundary phases. Examples of auxiliary oxides include SrO, BaO, Na₂O, K₂O, Fe₂O₃, and mixtures thereof.

It is noted that after the sintering operation, any alumina present in the monolith will be substantially converted to α-alumina. The “alpha” phase of alumina is thermodynamically favored at high temperatures, and the temperatures during sintering are sufficient convert substantially all of any other phases of alumina into the “alpha” phase. This is beneficial from a stability standpoint, as converting the alumina in the monolith to α-alumina means that phase transitions are not occurring during exposure of the monolith to the cyclic reforming conditions, where the presence of alternative phases of alumina might facilitate crack formation and/or propagation.

In some aspects, the monolith material (PQ) can further include an intermediate bond layer. The intermediate bond layer can be applied on monolith surfaces prior to forming a washcoat of active materials (e.g., catalyst). In such aspects, the intermediate bond layer provides a better adherence to the washcoated active material. In such aspects, the intermediate bond layer is a metal oxide, (M)ₓO_{y}, wherein (M) is at least one metal selected from the group consisting of Al, Si, Mg, Ca, Sr, Ba, K, Na, Ti, Zr, Hf, V, Nb, Ta, Cr, Mo, W, Mn, Fe, Ni, Co, Y, La, Ce, and mixtures thereof. Aluminum oxide (a.k.a. alumina), Al₂O₃, is a preferred metal oxide for the bond layer. As an example of how to form an intermediate bond layer, the selected metal oxide, (M)ₓO_{y}, can be dispersed in a solution to form a slurry. The slurry can then be washcoated on the monolith. The monolith washcoated with the selected metal oxide, (M)ₓO_{y}, is dried and sintered at temperatures in the range of 1100° C.-1600° C. to make the intermediate bonding layer.

It has been discovered that limiting the maximum porosity in the final sintered body tends to effectively, if not actually, limit interconnectivity of the pore spaces with other pore spaces to an extent that increases or maximizes volumetric heat capacity of the sintered body. The porosity ranges for a monolith or other structure can depend upon the desired final component performance properties, but are within a range defined by one or more of the minimum porosity values and one or more of the maximum porosity values, or any set of values not expressly enumerated between the minimums and maximums. Examples of suitable porosity values are 0 vol % to 20 vol % porosity, or 0 vol % to 15 vol %, or 0 vol % to 10 vol %, or 0 vol % to 5 vol %.

The sintered monolith and/or other formed ceramic structure can have any convenient shape suitable for use as a surface for receiving a catalyst or catalyst system. An example of a monolith can be an extruded honeycomb monolith. Honeycomb monoliths can be extruded structures that comprise many (e.g., a plurality, meaning more than one) small gas flow passages or conduits, arranged in parallel fashion with thin walls in between. A small reactor may include a single monolith, while a larger reactor can include a number of monoliths, while a still larger reactor may be substantially filled with an arrangement of many honeycomb monoliths. Each monolith may be formed by extruding monolith blocks with shaped (e.g., square, trigonal, or hexagonal) cross-section and two- or three-dimensionally stacking such blocks above, behind, and beside each other. Monoliths can be attractive as reactor internal structures because they provide high heat transfer capacity with minimum pressure drop.

In some aspects, density, measured by an Archimedes method well-known to the skilled in the art, can be 3.40 gram/cc or more, or 3.50 gram/cc or more, such as up to 3.95 gram/cc which is theoretical density of alumina, or possibly still higher if it contains heavier metal oxides. In some aspects, porosity can be nearly completely closed within the honeycomb monolith walls with the porosity being 10% or less, or 8.0% or less, such as down to 1.0% or possibly still lower.

In some aspects, honeycomb monoliths can be characterized as having open frontal area (or geometric void volume) between 30% to 70%, or 30% to 60%, or 40% to 70%, or 40% to 60%, or 45% to 55%. Additionally or alternately, a monolith can have a conduit density between 50 to 900 cells per square inch (CPSI), or 50 to 600, or 300 to 900, or 300 to 600, or 350 to 550. This roughly corresponds to 7 to 140 cells per square centimeter, or 45 to 140, or 7 to 95, or 45 to 95, or 55 to 85. In some aspects, this type of cell density roughly corresponds to cells or channels that have a diameter/characteristic cell side length of only a few millimeters, such as on the order of roughly one millimeter. Reactor media components, such as the monoliths or alternative bed media, can provide for channels that include a packing with an average wetted surface area per unit volume that ranges from 50 ft⁻¹ to 3000 ft⁻¹ (˜0.16 km⁻¹ to ˜10 km⁻¹), or from 100 ft⁻¹ to 2500 ft⁻¹ (˜0.32 km⁻¹ to −8.2 km⁻¹), or from 200 ft⁻¹ to 2000 ft⁻¹ (˜0.65 km⁻¹ to −6.5 km⁻¹), based upon the volume of the first reactor that is used to convey a reactant. These relatively high surface area per unit volume values can aid in achieving a relatively quick change in the temperature through the reactor.

Reactor media components can also provide for channels that include a packing that includes a high volumetric heat transfer coefficient (e.g., 0.02 cal/cm³s° C. or more, or 0.05 cal/cm³s° C. or more, or 0.10 cal/cal/cm³s° C. or more); that have low resistance to flow (low pressure drop); that have an operating temperature range consistent with the highest temperatures encountered during regeneration; that have high resistance to thermal shock; and/or that have high bulk heat capacity (e.g., 0.10 cal/cm³s° C. or more, or 0.20 cal/cm³s° C. or more). As with the high surface area values, these relatively high volumetric heat transfer coefficient values and/or other properties can aid in achieving a relatively quick change in the temperature through the reactor, such as generally illustrated by the relatively steep slopes in the exemplary temperature gradient profile graphs, such as in FIGS. 2(a) and 2(b) of FIG. 2. The cited values are averages based upon the volume of reactor used for conveyance of a reactant.

In various aspects, adequate heat transfer rate can be characterized by a heat transfer parameter, ΔTHT, below 500° C., or below 100° C., or below 50° C. The parameter ΔTHT, as used herein, is the ratio of the bed-average volumetric heat transfer rate that is needed for recuperation, to the volumetric heat transfer coefficient of the bed, hv. The volumetric heat transfer rate (e.g. cal/cm³ sec) that is sufficient for recuperation can be calculated as the product of the gas flow rate (e.g. g/sec) with the gas heat capacity (e.g. cal/g° C.) and desired end-to-end temperature change (excluding any reaction, e.g. ° C.), and then this quantity can be divided by the volume (e.g. cm³) of the reactor (or portion of a reactor) traversed by the gas. The volumetric heat transfer coefficient of the bed, hv, can typically be calculated as the product of an area-based coefficient (e.g. cal/cm²s° C.) and a specific surface area for heat transfer (av, e.g. cm²/cm³), often referred to as the wetted area of the packing.

In some aspects, monolith structures can be prepared with channels that are based on a shape that can be completely space-filling in two dimensions, but modified to have rounded features at vertices of the shape. Examples of suitable shapes for the channels in a monolith having rounded vertices can include rounded hexagons, rounded squares, and rounded rectangles. For such types of shapes, the cross-section of a channel can correspond to sets of parallel sides with rounded arcs connecting adjacent sides. The size and spacing of the channels can be similar to the size and spacing for conventional channels that do not use rounded vertices.

The rounded vertices can be formed in any convenient manner. In some aspects, the rounded vertices can be have a normalized radius of curvature of 0.15 to 0.65. Per the standard definition, a radius of curvature is defined as the radius of a circular arc that either corresponds to the shape of the rounded vertex, or that corresponds to the best fit circular arc for the rounded vertex (as determined by least squares). After determining a radius of curvature, a normalized radius of curvature can be calculated by dividing the radius of curvature by a characteristic length associated with the channel shape. For channel shapes based on rounded squares or rounded hexagons (or other shapes with regular lengths for the sides), the characteristic length is the distance between the mid-points of two parallel sides. For non-regular shapes such as rectangles, the characteristic length is the average of the distances between parallel sides. It is noted that the radius of curvature can vary between the vertices within an individual channel, so that the channels may not have a completely symmetric shape. As would be expected, the radius of curvature of a circle/substantially circular channel is simply the radius.

### Catalysts and Catalyst Systems

In various aspects, catalyst systems are provided for reforming of hydrocarbons, along with methods for using such catalyst systems. The catalyst systems can be deposited or otherwise coated on a surface or structure, such as a monolith, to achieve improved activity and/or structural stability. In this discussion, a catalyst system is defined to include at least one catalyst corresponding to one or more catalytic metals, optionally in the form of a metal oxide, and at least one metal oxide support layer. In some aspects, the catalyst and metal oxide support layer can be coated on the monolith at the same time, such as in the form of a washcoat layer on the support. In such aspects, the catalyst can be intermixed with the metal oxide support layer. Alternatively, the catalyst and metal oxide support layer can be deposited sequentially so that the support layer is deposited first, followed by the catalyst. In some aspects, the metal oxide support layer can correspond to a thermally stable metal oxide support layer, such as a metal oxide support layer that is thermally phase stable at temperatures of 800° C. to 1600° C. Optionally, an intermediate bonding layer can be applied to at least a portion of the monolith or other structure prior to depositing the catalyst system. The catalyst systems can be beneficial for use in cyclical reaction environments, such as reverse flow reactors or other types of reactors that are operated using flows in opposing directions and different times within a reaction cycle. The reaction conditions in cyclical reaction environments can also undergo swings in temperature and/or pressure during a reaction cycle. In still other aspects, a catalyst can be deposited without using a corresponding metal oxide support layer.

In some aspects, the catalyst system can correspond to one or more catalysts in a single zone. In other aspects, the catalyst system can correspond to a plurality of catalyst zones. Optionally in such aspects, at least one catalyst zone can include a catalyst that is different from the catalyst(s) in a second catalyst zone.

In some aspects, the catalyst system can include a thermally stable metal oxide support layer. A thermally stable metal oxide support layer corresponds to a metal oxide that is thermally phase stable with regard to structural phase changes at temperatures between 800° C. to 1600° C. In some aspects, such a thermally stable metal oxide support layer can be formed by coating a surface (such using a washcoat) with a metal oxide powder that has a surface area of 20 m²/g or less. For example, the metal oxide powder used for forming a thermally stable metal oxide coating can have a surface area of 0.5 m²/g to 20 m²/g, or 1.0 m²/g to 20 m²/g, or 5.0 m²/g to 20 m²/g. High temperature reforming refers to reforming that takes place at a reforming temperature of 1000° C. or more, or 1100° C. or more, or 1200° C. or more, such as up to 1500° C. or possibly still higher. In various aspects, a catalyst can be annealed at a temperature of 1000° C. or more, or 1100° C. or more, or 1200° C. or more, or 1300° C. or more, such as up to 1600° C. or possibly still higher. This temperature can be substantially similar to or greater than the peak temperature the catalyst is exposed to during a reforming process cycle. An annealing temperature that is substantially similar to a peak temperature can correspond to an annealing temperature that differs from the peak temperature by 0° C. to 50° C.

As an example of a thermally stable metal oxide support layer, alumina has a variety of phases, including α-Al₂O₃, γ-Al₂O₃, and θ-Al₂O₃. A metal powder of α-Al₂O₃ can typically have a surface area of 20 m²/g or less. By contrast, the γ-Al₂O₃ and θ-Al₂O₃ phases have higher surface areas, and a metal powder for use in a washcoat solution of γ-Al₂O₃ and/or θ-Al₂O₃ will have a surface area of greater than 20 m²/g. It is conventionally believed that phases such as θ-alumina or γ-alumina are superior as a supporting structure for a deposited catalyst, as the greater surface per gram of θ-alumina or γ-alumina will allow for availability of more catalyst active sites than α-alumina. However, phases such as γ-Al₂O₃ and θ-Al₂O₃ are not thermally phase stable at temperatures of 800° C. to 1600° C. At such high temperatures, phases such as γ-Al₂O₃ and θ-Al₂O₃ will undergo phase transitions to higher stability phases. For example, at elevated temperatures, γ-Al₂O₃ will first convert to Δ-Al₂O₃ at roughly 750° C.; then Δ-Al₂O₃ will convert to θ-Al₂O₃ at roughly 950° C.; then θ-Al₂O₃ will then convert to α-Al₂O₃ with further exposure to elevated temperatures between 1000° C. and 1100° C. Thus, α-Al₂O₃ is the thermally phase stable version of Al₂O₃ at temperatures of 800° C. to 1600° C.

In various aspects, one option for adding a catalyst system to a monolith can be to coat the monolith with a mixture of a catalyst (optionally in oxide form) and metal oxide support layer. For example, powders of the catalyst oxide and the metal oxide support layer can be used to form a washcoat that is then applied to the monolith (or other structure). This can result in a catalyst system where the catalyst is mixed within/distributed throughout the metal oxide support layer, as opposed to the catalyst being deposited on top of the metal oxide support layer. In other words, at least a portion of the catalyst system can correspond to a mixture of the catalyst and the support layer. In other aspects, any convenient method for depositing or otherwise coating the catalyst system on the monolith or other structure can be used. The weight of the catalyst system on the monolith (or other structure) can correspond to 0.1 wt % to 10 wt % of the total weight of the catalyst system plus monolith, or 0.5 wt % to 10 wt %, or 2.0 wt % to 10 wt %, or 0.1 wt % to 6.0 wt %, or 0.5 wt % to 6.0 wt %, or 2.0 wt % to 6.0 wt %.

A catalyst system can be applied to a monolith or other structure, for example, by applying the catalyst system as a washcoat suspension. To form a washcoat suspension, the catalyst system can be added to water to form an aqueous suspension having 10 wt % to 50 wt % solids. For example, the aqueous suspension can include 10 wt % to 50 wt % solids, or 15 wt % to 40 wt %, or 10 wt % to 30 wt %. Optionally, an acid or a base can be added to the aqueous suspension to reduce or raise, respectively, the pH so as to change the particle size distribution of the alumina catalyst and/or binder particles. For example, acetic acid or another organic acid can be added to achieve a pH of 3 to 4. The suspension can then be ball milled (or processed in another manner) to achieve a desired particle size for the catalyst particles, such as a particle size of 0.5 μm to 5 μm. After milling, the suspension can be stirred until time for use so that the particles are distributed substantially uniformly in the solution.

The washcoat suspension can then be applied to a monolith structure to achieve a desired amount of catalyst (such as nickel or rhodium) on the monolith surface. As an example, in one aspect a washcoat thickness of 10 microns was achieved by forming a washcoat corresponding to 10 wt % of the monolith structure. Any convenient type of monolith structure can be used to provide a substantial surface area for support of the catalyst particles. The washcoat can be applied to the monolith to form cells having inner surfaces coated with the catalyst. One option for applying the washcoat can be to dip or otherwise submerge the monolith in the washcoat suspension.

After clearing the cell channels of excess washcoat, the catalyst system coated on the monolith can be optionally dried. Drying can correspond to heating at 100° C. to 200° C. for 0.5 hours to 24 hours. After any optional drying, calcination can be performed. In some aspects, calcining can correspond to heating at 200° C. to 800° C. for 0.5 hours to 24 hours. In some other aspects, calcining can correspond to heating at 800° C. to 1300° C. for 0.5 hours to 24 hours.

In other aspects, a high temperature calcination step can be used, so that the calcining temperature for the catalyst system coated on the monolith is substantially similar to or greater than the peak temperature the monolith will be exposed to during the cyclic high temperature reforming reaction. For a monolith in a high temperature zone, this can correspond to calcining the catalyst system coated on the monolith at a temperature of 800° C. or more, or 1000° C. or more, or 1200° C. or more, or 1300° C. or more, such as up to 1600° C. or possibly still higher. It is noted that if multiple catalyst zones are present, the calcination for monoliths in different catalyst zones can be different.

It has been unexpectedly discovered that performing calcination at a temperature similar to or greater than the peak temperature during the cyclic high temperature reforming process can unexpectedly allow for improved activity for the catalyst system and/or adhesion of the catalyst system to the underlying monolith. Without being bound by any particular theory, it is believed that exposing the monolith and deposited catalyst system to elevated temperatures prior to exposure of the catalyst to a cyclic reaction environment can facilitate forming a stable interface between the catalyst system and the monolith. This stable interface can then have improved resistance to the high temperature oxidizing and/or reducing environment during the reforming process, resulting in improved stability for maintaining the catalyst system on the surface of the monolith.

One of the distinctions between using a catalyst system including a thermally stable metal oxide and a catalyst system that does not use a thermally stable oxide is that the catalyst system including the thermally stable metal oxide can have improved adhesion to the underlying support structure after exposure to the cyclic high temperature reforming environment.

Adhesion of the washcoat after operation can be quantified by the amount of force needed to de-adhere the washcoat. In prior operation, washcoats comprised of theta and gamma alumina were de-adhered with minimal force, such as an amount of force similar to a paint brush stroke (weak). In operation with the phase stable supports, the force needed to de-adhere the washcoat was high, similar to the scraping of dried epoxy off of a glass surface (strong). Due to these differences, only small amounts of washcoat could be de-adhered from the phase stable materials, whereas large amounts of washcoat could be de-adhered from the gamma and theta supports.

Other methods for evaluating adhesion of the washcoat include, but are not limited to, (i) a thermal cycling method, (ii) a mechanical attrition method, and (iii) an air-knife method. As a non-limiting example, the thermal cycling method can be performed by heating the washcoated materials to high temperatures in the range of 800 to 1300° C., cooling the heated substrates to ambient temperature, and repeating such a cycle at least five times. As another non-limiting example, the mechanical attrition method can be performed by placing the washcoated materials inside a plastic container and shaking the container on a vibration table for at least 30 minutes.

In various aspects, suitable catalytic metals can include, but are not limited to, Ni, Co, Fe, Pd, Rh, Ru, Pt, Ir, Cu, Ag, Au, Zr, Cr, Ti, V, Mo, Nb, and combinations thereof. The catalytic metal can be selected based on the desired type of catalytic activity. Such catalytic metals may be used in a catalyst in the form of a metal oxide. In some aspects, for reforming of hydrocarbons in the presence of H₂O and/or CO₂ to make hydrogen, Ni, Rh, Ru, Pd, Pt, Ir, Cu, Co, or a combination of thereof can be suitable catalytic metals. The weight of catalytic metal oxide in the catalyst system can range from 0.1 wt % to 70 wt %, or 1.0 wt % to 60 wt %, or 2.0 wt % to 50 wt %, relative to the total weight of the catalyst system. In some aspects where the catalytic metal corresponds to a precious metal or noble metal, the weight of catalytic metal oxide in the catalyst system can range from 0.1 wt % to 10 wt %, or 0.2 wt % to 7.0 wt %, or 0.5 wt % to 4 wt %.

The catalytic metals can be selected to provide long term stable performance at specific temperature zones of the catalytic bed. This can allow for steady methane conversion, phase stability with the metal oxide support, and reduced or minimized sintering of catalytic metals. As an example involving three catalyst zones, the catalyst system in a highest temperature catalytic zone (e.g. 800-1250° C.), which is exposed to some of highest temperatures and most severe temperature swings, can be composed of Ni as a catalytic metal (NiO as a catalytic metal oxide) and Al₂O₃ as a metal oxide support. It is noted that this catalyst system can at least partially convert to NiAl₂O₄ during portions of the cyclic reforming process. This catalyst system can be formed, for example, by using a mixture of NiO and Al₂O₃, as a washcoat on α-Al₂O₃ monoliths. In such an example, a catalyst system in a medium temperature catalytic zone (e.g. 600-1150° C.) can be composed of Ni and Rh as catalytic metals (NiO and Rh₂O₃ as catalytic metal oxide), and Al₂O₃ as a metal oxide support. To form this catalyst system, a mixture of NiO and Rh₂O₃, as the catalytic material and Al₂O₃ (optionally but preferably α-Al₂O₃) as a metal oxide support material can be washcoated on a monolith comprising of 95 wt % α-Al₂O₃, 4 wt % SiO₂ and 1 wt % TiO₂. In such an example, a catalyst system in a low temperature catalytic zone (e.g. 400-1050° C.) can be composed of Rh as catalytic metal (Rh₂O₃ as catalytic metal oxide) and α-Al₂O₃ as a metal oxide support. To form this catalyst system, a mixture of Rh₂O₃ and α-Al₂O₃ as the catalytic material can be washcoated on a monolith comprising 93 wt % α-Al₂O₃, 5 wt % SiO₂ and 2 wt % MgO.

In various aspects, suitable metals for the metal oxide support layer in the catalyst system can include, but are not limited to, Al, Si, Mg, Ca, Sr, Ba, K, Na, Ti, Zr, Hf, V, Nb, Ta, Cr, Mo, W, Mn, Fe, Ni, Co, Y, La, Ce, and combinations thereof. The metal (or metals) for the metal oxide support can be selected so that the metal oxide support substantially does not convert to metallic form under the reducing conditions present in the cyclic reaction environment. As an example, when the catalytic metal oxide is NiO, one option for a metal oxide support is Al₂O₃, preferably α-Al₂O₃. Another example of a suitable metal oxide support, optionally, in combination with NiO as the catalytic metal oxide, is a mixture of Al₂O₃ with SiO₂, MgO and/or TiO₂. In such an example, SiO₂ can combine with Al₂O₃ to form a mullite phase that could increase resistance to thermal shock and/or mechanical failure. Additionally or alternately, in such an example, MgO and/or TiO₂ can be added. The weight of metal oxide support in the catalyst bed can range from 1.0 wt % to 40 wt %, or 2.0 wt % to 30 wt %, or 3.0 wt % to 20 wt %, relative to the total weight of the monolith in the catalyst bed.

In various aspects, a metal oxide support layer (such as a thermally stable metal oxide support layer) can correspond to at least one oxide selected from the corundum group, stabilized zirconia, perovskite, pyrochlore, spinel, hibonite, zeolite, and mixtures thereof. The weight of metal oxide support can range from 1.0 wt % to 40 wt %, or 2.0 wt % to 30 wt %, or 3.0 wt % to 20 wt %, relative to the total weight of the monolith plus catalyst system.

One category of metal oxide support layers can correspond to traditional refractory oxides that are commonly used to form supported catalysts. For example, the metal oxide support can correspond to α-Al₂O₃, LaAlO₃, LaAl₁₁O₁₈, MgO, CaO, ZrO₂, TiO₂, CeO₂, Y₂O₃, La₂O₃, SiO₂, Na₂O, K₂O, and mixtures thereof. This group is defined herein as the “corundum” group of oxides, although many of the oxides in this group do not have the corundum lattice structure. For example, CeO₂ and MgO can both have a halite crystal structure. α-Al₂O₃ consists essentially of a dense arrangement of oxygen ions in hexagonal closest-packing with Al³⁺ ions in two-thirds of the available octahedral sites. LaAlO₃, often abbreviated as LAO, is an optically transparent ceramic oxide with a distorted perovskite structure. LaAl₁₁O₁₈ can be formed through the solid state reaction of LaAlO₃ and α-Al₂O₃. Plate-like crystals of LaAl₁₁O₁₈ are particularly useful as a metal oxide support since catalytic metals can be trapped between plate-like crystal structures. It suppresses sintering of minute catalytic metals in the active material which is washcoated on the monolith of the catalyst bed. Additional examples of oxides from the corundum group can include, but are not limited to: i) 95 wt % α-Al₂O₃ and 5 wt % SiO₂; ii) 93 wt % α-Al₂O₃, 5 wt % SiO₂ and 2 wt % MgO; iii) 94 wt % α-Al₂O₃, 4 wt % SiO₂, 2 wt % MgO and 1 wt % Na₂O; iv) 95 wt % α-Al₂O₃, 4 wt % SiO₂ and 1 wt % TiO₂; v) 7 wt % CeO₂ and 93 wt % MgO; vi) 5 wt % CaO and 95 wt % α-Al₂O₃; vii) 5 wt % MgO, 5 wt % CeO₂ and 90 wt % α-Al₂O₃; viii) 20 wt % ZrO₂ and 80 wt % CeO₂, ix) 5 wt % CeO₂, 20 wt % ZrO₂ and 75 wt % α-Al₂O₃, and x) 6 wt % La₂O₃ and 94 wt % α-Al₂O₃, based on the weight of metal oxide support.

As an example, the catalyst system can correspond to a mixture of NiO and Al₂O₃. Under the cyclic high temperature reforming conditions, the NiO and the Al 2 O 3 in the will react to form a mixed phase of NiO, NiAl₂O₄, and/or Al₂O₃. Additionally, based on cyclic exposure to oxidizing and reducing conditions, the catalyst can be converted from a substantially fully oxidized state, such as a combination of oxides including NiO, NiAl₂O₄ and Al₂O₃, to various states including at least some Ni metal supported on a surface. In this discussion, a catalyst system that includes both NiO and Al₂O₃ is referred to as an NiAl₂O₄ catalyst system.

Based on the stoichiometry for combining NiO and Al₂O₃ to form NiAl₂O₄, a catalyst including a molar ratio of Al to Ni of roughly 2.0 (i.e., a ratio of 2:1) could result in formation of NiAl₂O₄ with no remaining excess of NiO or Al₂O₃. Thus, one option for forming an NiAl₂O₄ catalyst is to combine NiO and Al₂O₃ to provide a stoichiometric molar ratio of Al to Ni of roughly 2.0. In some other aspects, an excess of NiO can be included in the catalyst relative to the amount of alumina in the support, so that at least some NiO is present in a fully oxidized state. In such aspects, the molar ratio of Al to Ni in the catalyst can be less than 2.0. For example, the molar ratio of Al to Ni in a NiO/NiAl₂O₄ catalyst can be 0.1 to 2.0, or 0.1 to 1.9, or 0.1 to 1.5, or 0.5 to 2.0, or 0.5 to 1.9, or 0.5 to 1.5, or 1.0 to 2.0, or 1.0 to 1.9, or 1.2 to 1.5, or 1.5 to 2.0, or 1.5 to 1.9. In still other aspects, an excess of Al₂O₃ can be included in the catalyst relative to the amount of Ni, so that at least some Al₂O₃ is present in a fully oxidized state. In such aspects, the molar ratio of Al to Ni in the catalyst can be greater than 2.0. For example, the molar ratio of Al to Ni in a NiAl₂O₄/Al₂O₃ catalyst can be 2.0 to 10, or 2.1 to 10, or 2.0 to 5.0, or 2.1 to 5.0, or 2.0 to 4.0, or 2.1 to 4.0.

In various aspects, a NiAl₂O₄ catalyst can be incorporated, for example, into a washcoat that is then applied to a surface or structure within a reactor, such as a monolith. By providing NiO and Al₂O₃ as a catalyst system that is then deposited on a separate monolith (which can then form NiAl₂O₄ under the cyclic conditions), the activity of the catalyst can be maintained for unexpectedly longer times relative to using a monolith that directly incorporates NiO and Al₂O₃ into the monolith structure.

When a composition is formed that includes both nickel oxide and alumina, the NiO and Al₂O₃ can react to form a compound corresponding to NiAl₂O₄. However, when NiO (optionally in the form of NiAl₂O₄) is exposed to reducing conditions, the divalent Ni can be reduced to form metallic Ni. Thus, under cyclic reforming conditions that include both high temperature oxidizing and reforming environments, at least a portion of NiAl₂O₄ catalyst can undergo cyclic transitions between states corresponding to Ni metal and Al₂O₃ and NiAl₂O₄. It is believed that this cyclic transition between states can allow a NiAl₂O₄ catalyst to provide unexpectedly improved activity over extended periods of time. Without being bound by any particular theory, it is believed that at least part of this improved activity for extended time periods is due to the ability of Ni to “re-disperse” during the successive oxidation cycles. It is believed this re-dispersion occurs in part due to the formation of NiAl₂O₄ from NiO and Al₂O₃. Catalyst sintering is a phenomenon known for many types of catalysts where exposure to reducing conditions at elevated temperature can cause catalyst to agglomerate on a surface. Thus, even if the surface area of the underlying surface remains high, the agglomeration of the catalyst may reduce the amount of available catalyst active sites, as the catalyst sinters and forms lower surface area deposits on the underlying surface. By contrast, it is believed that the cyclic transition between states can allow the Ni in an NiAl₂O₄ catalyst system to retain good dispersion, so that catalyst activity can be maintained. It is believed that further advantage can be obtained by using a sufficient amount of excess oxygen during the regeneration step so that all available Ni is oxidized back to NiO and/or NiAl₂O₄.

It is noted that by supplying both NiO as a catalyst and Al₂O₃ as a metal oxide support layer as part of the catalyst system, the alumina for forming NiAl₂O₄ is already provided as part of the catalyst system. It is believed that this reduces or minimizes interaction of Ni with any alumina that may be present in the monolith composition, and therefore reduces or minimizes degradation of the underlying monolith when exposed to successive cycles of high temperature oxidation and reduction.

NiO supported on yttria-stabilized zirconia (NiO/YSZ) is another example of an Ni-containing catalyst system that can be used for reforming. Although α-Al₂O₃ is phase stable, it is able to react with NiO at high temperature to form NiAl₂O₄. It is believed, however, that YSZ does not react with Ni (NiO) at high temperatures. Thus, it is believed that in the NiO/YSZ system, a cyclic oxidation and reduction of Ni to NiO and back to Ni metal does occur, but redispersion does not occur. However, NiO/YSZ can still provide stable reforming activity in a cyclic high temperature reforming environment. In some aspects, to assist with bonding of NiO/YSZ to a monolith, an intermediate oxide layer of α-Al₂O₃ can first be deposited as a washcoat on the monolith. The NiO/YSZ layer can then be deposited on the intermediate oxide layer.

NiO/YSZ represents an alternative type of catalyst system, as YSZ is a phase stable support that does not react with Ni to form a different material. In order to determine stability of the support oxide layer, a first sample of NiO/YSZ was exposed to calcining at 1300° C., while a second sample was steamed in air at 1000° C. X-ray diffraction was used to verify that no phase changes occurred. However, based on Brunauer—Emmett—Teller (BET) surface area analysis, it was observed that the surface area of the NiO/YSZ sample was roughly 53 m²/g prior to the calcining and steaming, and roughly 5 m²/g after the calcining and steaming.

Still another example of a catalyst system containing Ni can be NiO on a perovskite oxide, such as Sr_{0.65}La_{0.35}TiO₃ (SLT).

### Examples

A pilot scale reverse flow reactor was used to characterize thermal profiles within a reactor during operation. The internal configuration of the reactor was similar to FIG. 4. The pilot scale reactor was 12 inches (˜30 cm) long, with the interface between the mixer plates and the reaction zone being at roughly 4 inches (˜10 cm).

The mixing plates occupied roughly a half inch of the reactor volume. A flame diffuser was also included between the plurality of mixing plates and the first monolith in the reaction zone, to further facilitate mixing.

To characterize the temperature profile during operation, thermocouples were attached to interior surfaces of a monolith at various heights and various radial distances from the reactor center. A cyclic steam methane reforming reaction was then performed for an extended period. The temperature variation within the reactor was characterized based on the difference in temperature between thermocouples at the same height in the reactor at different radial distances from the center of the reactor.

The RFR cycle was based on a 15 second reforming step and 15 second regeneration step separated by short purges. During RFR regeneration, fuel was fed through a central sparger (a sparger incorporated into the distributor plate at location 610 in FIG. 4) and oxidant through an outer doughnut. The two flows were kept separate prior to the mixer to prevent ignition. Inert gas (N2 or CO₂) was added to pressure balance the inner and outer flows and dilute the flame temperature.

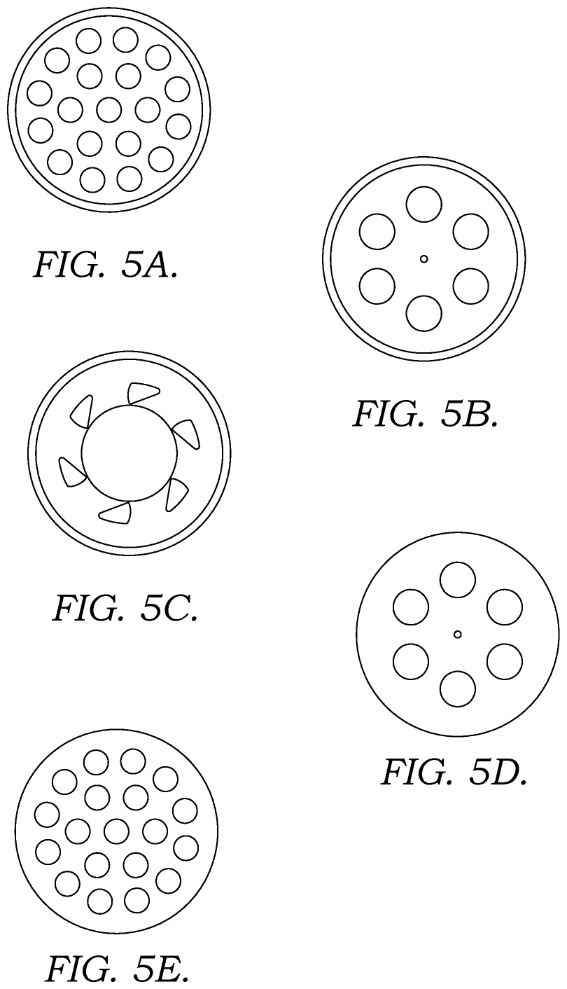

In a first group of runs, a conventional mixer configuration based on a mixer corresponding to 5 plates was used in the pilot scale reactor. The mixer plates are shown in FIG. 5A to 5E. As shown in FIGS. 5A to 5E, the plates are symmetric, with the plates in FIG. 5A and FIG. 5E being the same, and the plates in FIG. 5B and FIG. 5D being the same. It is noted that portions of the openings in FIG. 5A and FIG. 5B have overlap. Similarly, the openings in FIG. 5D and FIG. 5E have overlap. Additionally, the openings in the plate in FIG. 5E are of roughly uniform size. It is noted that for this comparative run, a flame diffuser used was different from the flame diffuser used in connection with the second set of runs.

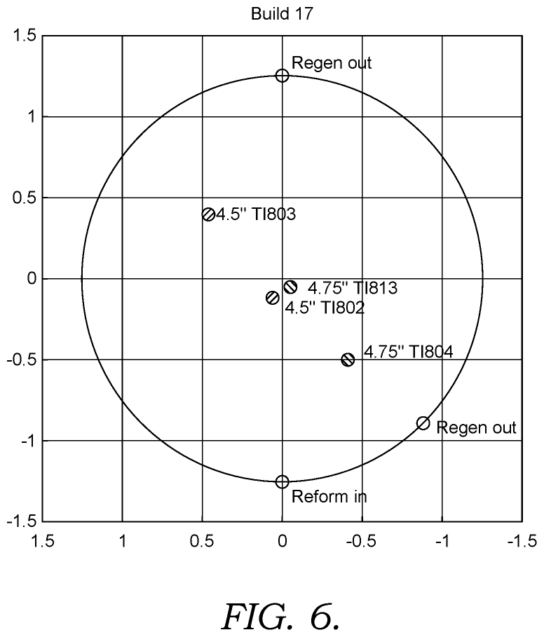

To investigate the temperature profile, pairs of thermocouples were inserted into the first monolith at depths of 0.5 inches and 0.75 inches below the diffuser. The radial and angular locations of these thermocouples are shown in FIG. 6. As shown in FIG. 6, the thermocouples allow the temperature to be sampled at roughly the center of the monolith and at a radial location roughly halfway to the edge of the reactor. For reference, FIG. 6 also shows the radial and angular locations of the reforming inlet and the regeneration outlets for the reactor.

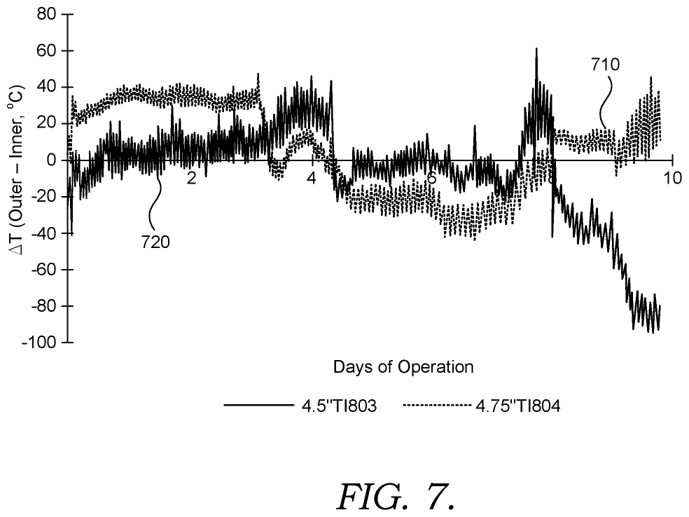

FIG. 7 shows the difference in temperature between the thermocouples at 0.5 inches inside the top of the first monolith in the reaction zone (plot 710) and at 0.75 inches inside the top of the first monolith (plot 720). It is noted that temperature would be expected to decrease as the gas flow from combustion travels downstream through the reactor, and this decrease in temperature would be expected to reduce variations in the temperature at a given cross-section. The difference shown in FIG. 7 is calculated by subtracting the temperature at the inner thermocouple from the temperature at the outer thermocouple. FIG. 7 shows this temperature differential for both pairs of thermocouples over the course of an extended run. As shown in FIG. 7, radial temperature variations of up to 100° C. were observed. Additionally, the temperature differential was not constant over time. For example, for plot 710, the temperature differential ranged from +40° C. to −40° C. Plot 720 showed still larger variations over time. FIG. 7 illustrates the difficulty of maintaining temperature control in a high temperature cyclic reforming environment using a conventional set of mixer plates.

In a second group of runs, the series of plates shown in FIGS. 2A to 2E were used in the pilot reactor. Additionally, a flame diffuser was placed between plate 2E and the beginning of the reaction zone. The flame diffuser had a fine porous structure to facilitate small scale mixing. The flame diffuser was formed using a 3D printed “log cabin” design. In one set of runs for the second group of runs, the diffuser was made of nickel aluminate. In another set of runs, the diffuser was made of alumina.

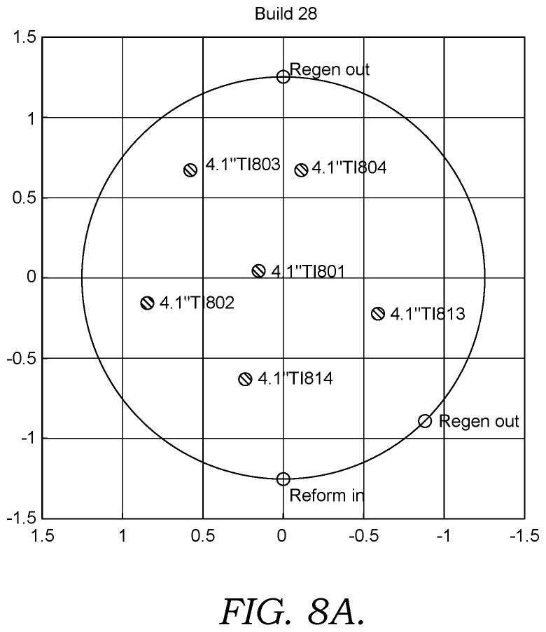

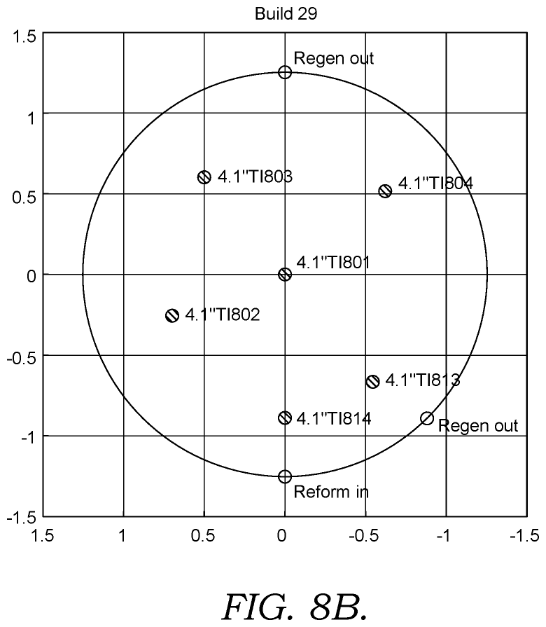

In the second series of runs, the thermocouples were placed 0.125 inches inside of the top of the first monolith in the reaction zone. The depth of placement and location of the thermocouples is shown in FIG. 8A and FIG. 8B. It is noted that the thermocouples placed only 0.125 inches inside the top monolith should have increased temperature sensitivity relative to thermocouples placed at 0.5 inches or 0.75 inches (as was used for the thermocouples shown in FIG. 6). FIG. 8A corresponds to the runs using the nickel aluminate diffuser, while FIG. 8B corresponds to the runs using the alumina diffuser.

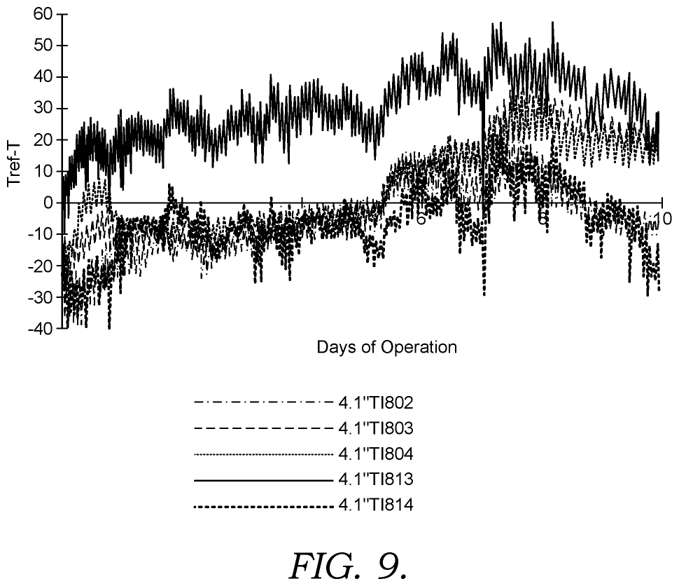

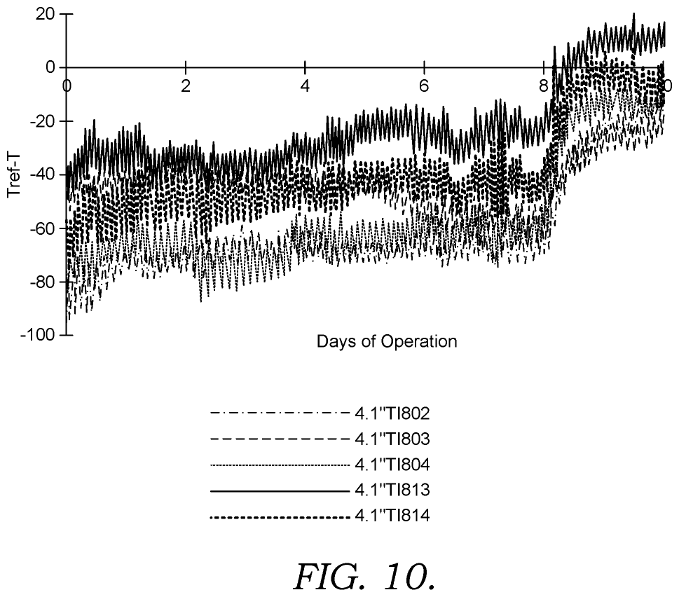

FIG. 9 shows the results from the runs using the nickel alumina diffuser and the thermocouple locations in FIG. 8A. FIG. 10 shows the results from the set of runs using the alumina diffuser and the thermocouple positions shown in FIG. 8B. As shown in FIG. 9 and FIG. 10, the temperature variation was only around 30-60° C. when using the series of plates shown in FIGS. 2A to 2E along with a diffuser. This can be seen by comparing the top line and the bottom line in FIG. 9 at any given time. This represents the maximum temperature differential between any two thermocouples for the configuration shown in FIGS. 2A to 2E. For comparison, when a similar thermocouple configuration was used for the configuration shown in FIG. 5, the temperature variation was up to 100° C. or even larger. Thus, the improved mixing plate configuration in FIGS. 2A to 2E provided a substantial improvement in temperature uniformity.

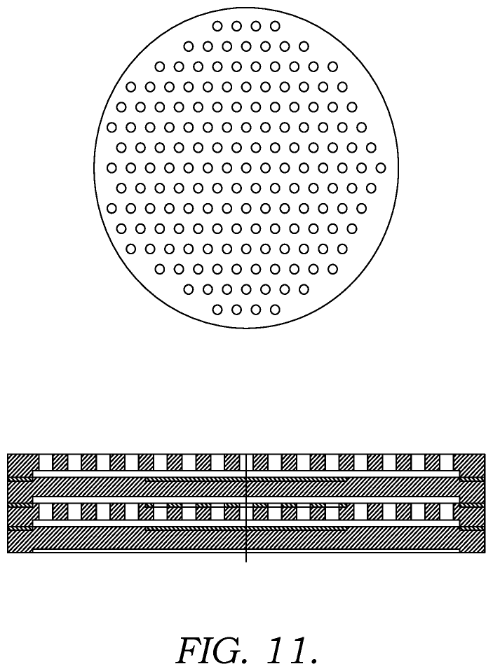

In still another set of runs, the series of plates shown in FIGS. 3A to 3E were used as the mixer plates, in combination with a diffuser made from silicon nitride. The silicon nitride diffuser was composed of a stack of four perforated plates, with each plate having an open frontal area of roughly 25%. A representative perspective and side view of the perforated plate silicon nitride diffuser is shown in FIG. 11.

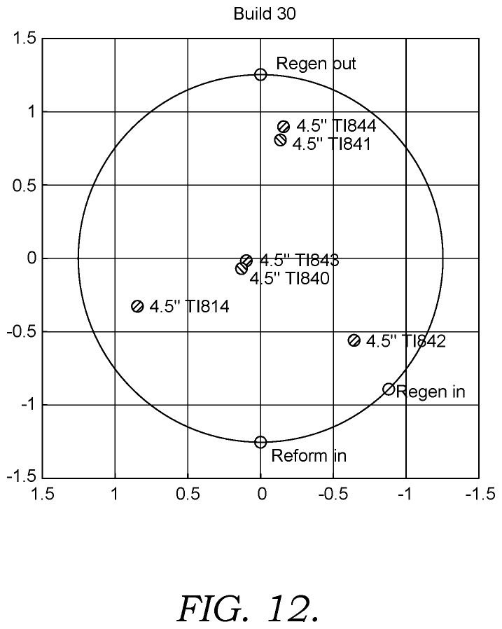

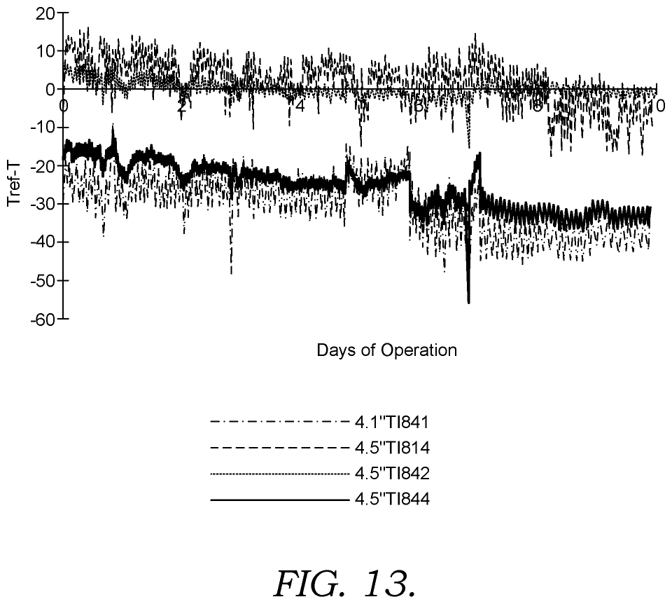

FIG. 12 shows the placement of the thermocouples for this additional set of runs, while FIG. 13 shows the results from reforming runs using the plates from FIGS. 3A to 3E and the silicon nitride diffuser. It is noted that some thermocouples were placed 0.125 inches within the monolith while others were placed 0.5 inches from the top, as indicated in FIG. 12. As shown in FIG. 13, the temperature variation was further reduced to 20° C. to 50° C., and this temperature variation was similar for the thermocouples at both heights. This is believed to be due to the extra mixing that is facilitated by having the diffuser caps above the openings for the plates in FIG. 3C, FIG. 3D, and FIG. 3E. Again, this is in contrast to the substantially higher temperature differentials of up to 100° C. or more that were observed in additional runs on the configuration shown in FIGS. 5A-5E.

### Additional Embodiments

Embodiment 1. A reverse flow reactor, comprising: a recuperation zone comprising at least one recuperation zone inlet and at least one recuperation zone outlet, the recuperation zone comprising a primary flow path in fluid communication with the at least one recuperation zone inlet and the at least one recuperation zone outlet; a reaction zone comprising at least a reaction zone inlet and a reaction zone outlet; one or more secondary reactor inlets in fluid communication with the recuperation zone; and a plurality of mixing plates arranged in series between the recuperation zone and the reaction zone, the plurality of mixing plates comprising at least a first plate, a second plate, and a third plate, the first plate being closer to the recuperation zone than the second plate and the third plate, the third plate being closer to the reaction zone than the first plate and the second plate, the first plate comprising a first inner portion and a first outer portion, the first inner portion having an area corresponding to 20% to 40% of the cross-sectional area of the first plate, an open area of the first inner portion corresponding to 5% or less of the area of the first inner portion, the first outer portion comprising a plurality of first openings, the plurality of first openings having an open area comprising 20% to 50% of an area of the first outer portion, the second plate comprising a second inner portion and a second outer portion, the second inner portion having an area corresponding to 20% to 40% of the cross-sectional area of the second plate, an open area of the second outer portion corresponding to 5% or less of an area of the second outer portion, the second inner portion comprising at least one second opening, the at least one second opening having an open area comprising 20% to 100% of the second inner portion, and the third plate comprising a third inner portion and a third outer portion, the third inner portion having an area corresponding to 20% to 40% of the cross-sectional area of the third plate, the third inner portion comprising at least one third inner opening, the third outer portion comprising a plurality of third outer openings, an average diameter of the third outer openings being greater than an average diameter of the at least one third inner opening, the plurality of third outer openings having a combined area that is 70% or more of a total combined area of the plurality of third outer openings and the at least one third inner opening.

Embodiment 2. The reverse flow reactor of Embodiment 1, wherein the reactor further comprises a diffuser between the third plate and the reaction zone, or wherein the reaction zone comprises at least one monolith, or a combination thereof.

Embodiment 3. The reverse flow reactor of any of the above embodiments, wherein the cross-sectional area of the first plate is substantially the same as an interior cross-sectional area of the reactor at the location of the first plate.

Embodiment 4. The reverse flow reactor of any of the above embodiments, wherein the first plate is adjacent to the second plate, and wherein the second plate is adjacent to the third plate.

Embodiment 5. The reverse flow reactor of any of the above embodiments, wherein an open area of the plurality of third outer openings comprises 20% to 50% of an area of the third outer portion.

Embodiment 6. The reverse flow reactor of any of the above embodiments, wherein the first inner portion comprises substantially no open area.

Embodiment 7. The reverse flow reactor of any of the above embodiments, wherein the open area of the plurality of first openings has substantially no overlap with an open area of a plate adjacent to the first plate.

Embodiment 8. The reverse flow reactor of any of the above embodiments, wherein the open area of the plurality of third outer openings has an overlap with an open area of a plate adjacent to the third plate of 15% or more, relative to a total open area of the plurality of third outer openings.

Embodiment 9. The reverse flow reactor of any of Embodiments 1-7, wherein the open area of the plurality of third outer openings has substantially no overlap with an open area of a plate adjacent to the third plate.

Embodiment 10. The reverse flow reactor of any of the above embodiments, wherein the second plate is adjacent to the first plate; or wherein the second plate is adjacent to the third plate; or a combination thereof.

Embodiment 11. The reverse flow reactor of any of the above embodiments, wherein the third plate further comprises one or more diffusion caps over at least a portion of the plurality of third outer openings.

Embodiment 12. The reverse flow reactor of any of the above embodiments, wherein the plurality of mixing plates further comprises a fourth plate and a fifth plate between the first plate and the second plate, the fourth plate being adjacent to the first plate, the fifth plate being adjacent to the second plate, the fourth plate comprising a fourth inner portion and a fourth outer portion, the fourth inner portion having an area corresponding to 20% to 40% of the cross-sectional area of the fourth plate, an open area of the fourth outer portion corresponding to 5% or less of an area of the fourth outer portion, the fourth inner portion comprising at least one fourth opening, the at least one fourth opening having an open area comprising 20% to 100% of the fourth inner portion, and the fifth plate comprising a fifth inner portion and a fifth outer portion, the fifth inner portion having an area corresponding to 20% to 40% of the cross-sectional area of the fifth plate, an open area of the fifth inner portion corresponding to 5% or less of the area of the fifth inner portion, the fifth outer portion comprising a fifth plurality of openings, the fifth plurality of openings having an open area comprising 20% to 50% of an area of the fifth outer portion.

Embodiment 13. The reverse flow reactor of any of the above embodiments, wherein the plurality of mixing plates further comprises a sixth plate and a seventh plate between the second plate and the third plate, the sixth plate being adjacent to the second plate, the seventh plate being adjacent to the third plate, the sixth plate comprising a sixth inner portion and a sixth outer portion, the sixth inner portion having an area corresponding to 20% to 40% of the cross-sectional area of the sixth plate, an open area of the sixth inner portion corresponding to 5% or less of the area of the sixth inner portion, the sixth outer portion comprising a sixth plurality of openings, the sixth plurality of openings having an open area comprising 20% to 50% of an area of the sixth outer portion, and the seventh plate comprising a seventh inner portion and a seventh outer portion, the seventh inner portion having an area corresponding to 20% to 40% of the cross-sectional area of the seventh plate, an open area of the seventh outer portion corresponding to 5% or less of an area of the seventh outer portion, the seventh inner portion comprising at least one seventh opening, the at least one seventh opening having an open area comprising 20% to 100% of the seventh inner portion, wherein optionally the sixth plate further comprises one or more diffusion caps over at least a portion of the plurality of sixth openings, and wherein optionally the seventh plate comprises at least one diffusion cap over the at least one seventh opening; or a combination thereof.

Embodiment 14. The reverse flow reactor of any of the above embodiments, wherein a ratio of the average diameter of the third outer openings to the average diameter of the at least one third inner opening is 1.5 or more.

Embodiment 15. A method for performing an endothermic reaction in the reverse flow reactor of any of the above embodiments, comprising: introducing a fuel flow into the recuperation zone; introducing an oxygen-containing flow into the secondary reactor inlets, the secondary reactor inlets being in fluid communication with the recuperation zone in proximity to the first plate of the plurality of mixing plates; passing the fuel flow and the oxygen-containing flow through the mixing plates to form a mixed flow; combusting at least a portion of the fuel in the mixed flow to form a heated gas flow; transferring heat from the heated gas flow to at least one surface in the reaction zone; exhausting the heated gas flow from the reaction zone; passing a reactant flow into the reaction zone; performing an endothermic reaction in the reaction zone to form a reaction product; and exhausting the reaction product from the recuperation zone, wherein the endothermic reaction optionally comprises hydrocarbon reforming.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

1. A reverse flow reactor, comprising:
a recuperation zone comprising at least one recuperation zone inlet and at least one recuperation zone outlet, the recuperation zone comprising a primary flow path in fluid communication with the at least one recuperation zone inlet and the at least one recuperation zone outlet;
a reaction zone comprising at least a reaction zone inlet and a reaction zone outlet;
one or more secondary reactor inlets in fluid communication with the recuperation zone; and
a plurality of mixing plates arranged in series between the recuperation zone and the reaction zone,
the plurality of mixing plates comprising at least a first plate, a second plate, and a third plate, the first plate being closer to the recuperation zone than the second plate and the third plate, the third plate being closer to the reaction zone than the first plate and the second plate,
the first plate comprising a first inner portion and a first outer portion, the first inner portion having an area corresponding to 20% to 40% of the cross-sectional area of the first plate, an open area of the first inner portion corresponding to 5% or less of the area of the first inner portion, the first outer portion comprising a plurality of first openings, the plurality of first openings having an open area comprising 20% to 50% of an area of the first outer portion,
the second plate comprising a second inner portion and a second outer portion, the second inner portion having an area corresponding to 20% to 40% of the cross-sectional area of the second plate, an open area of the second outer portion corresponding to 5% or less of an area of the second outer portion, the second inner portion comprising at least one second opening, the at least one second opening having an open area comprising 20% to 100% of the second inner portion, and
the third plate comprising a third inner portion and a third outer portion, the third inner portion having an area corresponding to 20% to 40% of the cross-sectional area of the third plate, the third inner portion comprising at least one third inner opening, the third outer portion comprising a plurality of third outer openings, an average diameter of the third outer openings being greater than an average diameter of the at least one third inner opening, the plurality of third outer openings having a combined area that is 70% or more of a total combined area of the plurality of third outer openings and the at least one third inner opening.

2. The reverse flow reactor of claim 1, wherein the reactor further comprises a diffuser between the third plate and the reaction zone.

3. The reverse flow reactor of claim 1, wherein the cross-sectional area of the first plate is substantially the same as an interior cross-sectional area of the reactor at the location of the first plate.

4. The reverse flow reactor of claim 1, wherein the first plate is adjacent to the second plate, and wherein the second plate is adjacent to the third plate.

5. The reverse flow reactor of claim 1, wherein an open area of the plurality of third outer openings comprises 20% to 50% of an area of the third outer portion.

6. The reverse flow reactor of claim 1, wherein the first inner portion comprises substantially no open area.

7. The reverse flow reactor of claim 1, wherein the open area of the plurality of first openings has substantially no overlap with an open area of a plate adjacent to the first plate.

8. The reverse flow reactor of claim 1, wherein the open area of the plurality of third outer openings has an overlap with an open area of a plate adjacent to the third plate of 15% or more, relative to a total open area of the plurality of third outer openings.

9. The reverse flow reactor of claim 1, wherein the open area of the plurality of third outer openings has substantially no overlap with an open area of a plate adjacent to the third plate.

10. The reverse flow reactor of claim 1, wherein the second plate is adjacent to the first plate; or wherein the second plate is adjacent to the third plate; or a combination thereof.

11. The reverse flow reactor of claim 1, wherein the third plate further comprises one or more diffusion caps over at least a portion of the plurality of third outer openings.

12. The reverse flow reactor of claim 1, wherein the plurality of mixing plates further comprises a fourth plate and a fifth plate between the first plate and the second plate, the fourth plate being adjacent to the first plate, the fifth plate being adjacent to the second plate, the fourth plate comprising a fourth inner portion and a fourth outer portion, the fourth inner portion having an area corresponding to 20% to 40% of the cross-sectional area of the fourth plate, an open area of the fourth outer portion corresponding to 5% or less of an area of the fourth outer portion, the fourth inner portion comprising at least one fourth opening, the at least one fourth opening having an open area comprising 20% to 100% of the fourth inner portion, and
the fifth plate comprising a fifth inner portion and a fifth outer portion, the fifth inner portion having an area corresponding to 20% to 40% of the cross-sectional area of the fifth plate, an open area of the fifth inner portion corresponding to 5% or less of the area of the fifth inner portion, the fifth outer portion comprising a fifth plurality of openings, the fifth plurality of openings having an open area comprising 20% to 50% of an area of the fifth outer portion.

13. The reverse flow reactor of claim 1, wherein the plurality of mixing plates further comprises a sixth plate and a seventh plate between the second plate and the third plate, the sixth plate being adjacent to the second plate, the seventh plate being adjacent to the third plate, the sixth plate comprising a sixth inner portion and a sixth outer portion, the sixth inner portion having an area corresponding to 20% to 40% of the cross-sectional area of the sixth plate, an open area of the sixth inner portion corresponding to 5% or less of the area of the sixth inner portion, the sixth outer portion comprising a sixth plurality of openings, the sixth plurality of openings having an open area comprising 20% to 50% of an area of the sixth outer portion, and
the seventh plate comprising a seventh inner portion and a seventh outer portion, the seventh inner portion having an area corresponding to 20% to 40% of the cross-sectional area of the seventh plate, an open area of the seventh outer portion corresponding to 5% or less of an area of the seventh outer portion, the seventh inner portion comprising at least one seventh opening, the at least one seventh opening having an open area comprising 20% to 100% of the seventh inner portion.

14. The reverse flow reactor of claim 13, wherein the sixth plate further comprises one or more diffusion caps over at least a portion of the plurality of sixth openings; or wherein the seventh plate comprises at least one diffusion cap over the at least one seventh opening; or a combination thereof.

15. The reverse flow reactor of claim 1, wherein the reaction zone comprises at least one monolith.

16. The reverse flow reactor of claim 1, wherein a ratio of the average diameter of the third outer openings to the average diameter of the at least one third inner opening is 1.5 or more.

17. A method for performing an endothermic reaction in the reverse flow reactor of claim 1, comprising:
introducing a fuel flow into the recuperation zone;
introducing an oxygen-containing flow into the secondary reactor inlets, the secondary reactor inlets being in fluid communication with the recuperation zone in proximity to the first plate of the plurality of mixing plates;
passing the fuel flow and the oxygen-containing flow through the mixing plates to form a mixed flow;
combusting at least a portion of the fuel in the mixed flow to form a heated gas flow;
transferring heat from the heated gas flow to at least one surface in the reaction zone;
exhausting the heated gas flow from the reaction zone;
passing a reactant flow into the reaction zone;
performing an endothermic reaction in the reaction zone to form a reaction product; and
exhausting the reaction product from the recuperation zone.

18. The method of claim 17, wherein the endothermic reaction comprises hydrocarbon reforming.
